(19) United States
(12) Patent Application Publication
(10) Pub. No.: US 2025/0239647 A1
(43) Pub. Date: Jul. 24, 2025

(54) COMPOSITE SOLID ELECTROLYTE AND SECONDARY BATTERY INCLUDING THE SAME

(71) Applicant: Samsung Electronics Co., Ltd., Suwon-si (KR)

(72) Inventors: Sewon Kim, Suwon-si (KR); Yongsu Kim, Suwon-si (KR); Taehee Kim, Suwon-si (KR); Jusik Kim, Suwon-si (KR)

(21) Appl. No.: 19/021,477

(22) Filed: Jan. 15, 2025

(30) Foreign Application Priority Data
Jan. 23, 2024 (KR) 10-2024-0010148

(51) Int. Cl. H01M 10/0562; H01M 10/0567; H01M 10/0568; H01M 10/0569; H01M 10/0585; H01M 10/42

(52) U.S. Cl. CPC H01M 10/0562; H01M 10/0567; H01M 10/0568; H01M 10/0569; H01M 10/0585; H01M 10/4235; H01M 2300/0034; H01M 2300/0071; H01M 2300/0094

(57) ABSTRACT

A composite solid electrolyte and a secondary battery including the same, wherein the composite solid electrolyte includes a first region, and a second region covering at least a portion of the first region. The first region includes an oxide solid electrolyte, the second region includes LiF, and in the second region, a content of the LiF at a surface side of the composite solid electrolyte is less than a content of the LiF at an interface side between the first region and the second region. When a depth profile of the composite solid electrolyte is analyzed by X-ray photoelectron spectroscopy, the second region includes a 2-1 region having a content of the LiF of about 23 atomic percent to about 40 atomic percent based on a total 100 atomic percent of the 2-1 region.

### CROSS-REFERENCE TO RELATED APPLICATION

This application is based on and claims priority to Korean Patent Application No. 10-2024-0010148, filed on Jan. 23, 2024, in the Korean Intellectual Property Office and all the benefits accruing therefrom under 35 U.S.C. § 119, the content of which is herein incorporated by reference in its entirety.

### BACKGROUND

### 1. Field

The disclosure relates to a composite solid electrolyte and a secondary battery including the same.

### 2. Description of the Related Art

Secondary batteries, for example, lithium secondary batteries, may provide improved specific energy (watt-hour per kilogram, Wh/kg) and/or energy density (watt-hour per cubic centimeter, Wh/cc).

Secondary batteries may include a solid electrolyte to improve stability. When secondary batteries adopt a solid electrolyte, for example, the interfacial resistance between a cathode and the solid electrolyte may increase. A need remains for improved solid electrolytes for secondary batteries.

### SUMMARY

An aspect provides a composite solid electrolyte including a coating layer with a new composition.

Another aspect provides a secondary battery including the composite solid electrolyte.

Additional aspects will be set forth in part in the description which follows and, in part, will be apparent from the description, or may be learned by practice of the presented embodiments of the disclosure.

According to an aspect, a composite solid electrolyte including a first region and a second region covering at least a portion of the first region, wherein the first region includes an oxide solid electrolyte and the second region includes LiF. In the second region, a content of the LiF at a surface side of the composite solid electrolyte is less than a content of the LiF at an interface side between the first region and the second region, and when a depth profile of the composite solid electrolyte is analyzed by X-ray photoelectron spectroscopy (XPS), the second region includes a 2-1 region having a content of the LiF of about 23 atomic percent (at %) to about 40 at % based on a total 100 atomic percent (100 at %) of the 2-1 region.

According to another aspect, a composite solid electrolyte including a first region, and a second region covering at least a portion of the first region, wherein the first region includes an oxide-based solid electrolyte, the second region includes LiF. In the second region, a content of the LiF at a surface side of the composite solid electrolyte is less than a content of the LiF at an interface side between the first region and the second region, and when a depth profile of the composite solid electrolyte is analyzed by X-ray photoelectron spectroscopy (XPS), the second region includes a 2-1 region having a content of the LiF of about 23 atomic percent (at %) or more based on a total 100 atomic percent (100 at %) of the 2-1 region.

According to another aspect, there is provided a secondary battery including a cathode, an anode, and an electrolyte layer disposed between the cathode and the anode, wherein the electrolyte layer includes the composite solid electrolyte, and the second region of the composite solid electrolyte is disposed adjacent to the cathode.

In an aspect, a method of making a composite solid electrolyte including providing a first region comprising an oxide solid electrolyte and disposing a second region on at least a portion of the first region to provide the composite solid electrolyte. The second region includes LiF and a content of the LiF at a surface side of the composite solid electrolyte is less than a content of the LiF at an interface side between the first region and the second region, and when a depth profile of the composite solid electrolyte is analyzed by in X-ray photoelectron spectroscopy, the second region includes a 2-1 region having a content of the LiF of about 23 atomic percent to about 40 at % based on a total 100 at % of the 2-1 region.

### BRIEF DESCRIPTION OF THE DRAWINGS

The patent or application file contains at least one drawing executed in color. Copies of this patent or patent application publication with color drawings will be provided by the Office upon receipt and payment of the necessary fee.

The above and other aspects, features, and advantages of certain embodiments will be more apparent from the following description taken in conjunction with the accompanying drawings, in which:

FIG. 1 is a schematic cross-sectional view illustrating an embodiment of a structure of a composite solid electrolyte;

FIG. 2 is a schematic cross-sectional view illustrating an embodiment of a composite solid electrolyte;

FIG. 3 is a schematic cross-sectional view illustrating a structure of a composite solid electrolyte of the related art;

FIG. 4 is a schematic cross-sectional view illustrating a structure of a composite solid electrolyte of the related art;

FIG. 5 is a schematic cross-sectional view illustrating a composite solid electrolyte of the related art;

FIG. 6 is a schematic cross-sectional view illustrating an embodiment of a structure of a secondary battery;

FIG. 7 is a schematic cross-sectional view illustrating an embodiment of a structure of a secondary battery;

FIG. 8 is a schematic cross-sectional view illustrating an embodiment of a structure of a secondary battery;

FIG. 9 is a schematic cross-sectional view illustrating an embodiment of a structure of a secondary battery;

FIG. 10 is a graph illustrating sputter time (minutes, min) versus atomic ratio (percent) of an X-ray photoelectron spectroscopy (XPS) depth profile analysis of a surface of a composite solid electrolyte prepared in Example 1;

FIG. 11 is a graph illustrating sputter time (min) versus atomic ratio (%) of an XPS depth profile analysis of a surface of a composite solid electrolyte prepared in Example 2;

FIG. 12 is a graph illustrating sputter time (min) versus atomic ratio (%) of an XPS depth profile analysis of a surface of a composite solid electrolyte prepared in Comparative Example 1.

FIG. 13 is a graph illustrating sputter time (min) versus atomic ratio (%) of an XPS depth profile analysis of a surface of a composite solid electrolyte prepared in Comparative Example 2;

FIG. 14 is a graph illustrating atomic ratio (%) of an XPS depth profile analysis of four points on the surface of the composite solid electrolyte prepared in Example 1 for a sputter time of 0 minutes (top view) and a sputter time of 5 minutes (bottom view);

FIG. 15 is a graph illustrating atomic ratio (%) of an XPS depth profile analysis of four points on the surface of the composite solid electrolyte prepared in Example 2 for a sputter time of 0 minutes (top view) and a sputter time of 5 minutes (bottom view);

FIG. 16 is a graph illustrating atomic ratio (%) of an XPS depth profile analysis of four points on the surface of the composite solid electrolyte prepared in Comparative Example 1 for a sputter time of 0 minutes (top view) and a sputter time of 5 minutes (bottom view);

FIG. 17 is a graph illustrating atomic ratio (%) of an XPS depth profile analysis of four points on the surface of the composite solid electrolyte prepared in Comparative Example 2 for a sputter time of 0 minutes (top view) and a sputter time of 5 minutes (bottom view);

FIG. 18 is a graph illustrating potential (volts versus Li⁺/Li) versus areal capacity (milliamperes per square centimeter, mAh/cm²) as a charge/discharge profile of a hybrid secondary battery of Example 1;

FIG. 19 is a graph illustrating potential (V versus Li⁺/Li) versus areal capacity (mAh/cm²) as a charge/discharge profile of the hybrid secondary battery of Example 1;

FIG. 20 is a graph illustrating potential (V versus Li⁺/Li) versus areal capacity (mAh/cm²) as a charge/discharge profile of a hybrid secondary battery of Example 2;

FIG. 21 is a graph illustrating potential (V versus Li⁺/Li) versus areal capacity (mAh/cm²) as a charge/discharge profile of the hybrid secondary battery of Example 2;

FIG. 22 is a graph illustrating potential (V versus Li⁺/Li) versus areal capacity (mAh/cm²) as a charge/discharge profile of a hybrid secondary battery of Example 3;

FIG. 23 is a graph illustrating potential (V versus Li⁺/Li) versus areal capacity (mAh/cm²) as a charge/discharge profile of a hybrid secondary battery of Example 4;

FIG. 24 is a graph illustrating potential (V versus Li⁺/Li) versus areal capacity (mAh/cm²) as a charge/discharge profile of a hybrid secondary battery of Comparative Example 1;

FIG. 25 is a graph illustrating potential (V versus Li⁺/Li) versus areal capacity (mAh/cm²) as a charge/discharge profile of the hybrid secondary battery of Comparative Example 1;

FIG. 26 is a graph illustrating potential (V versus Li⁺/Li) versus areal capacity (mAh/cm²) as a charge/discharge profile of a hybrid secondary battery of Comparative Example 2;

FIG. 27 is a graph illustrating potential (V versus Li⁺/Li) versus areal capacity (mAh/cm²) as a charge/discharge profile of the hybrid secondary battery of Comparative Example 2;

FIG. 28 is a scanning electron micrograph (SEM) of a cross section of the composite solid electrolyte prepared in Example 1; and

FIGS. 29A to 29D are energy-dispersive X-ray spectroscopy (EDX) mapping images of fluorine, sulfur, lanthanum, and zirconium, respectively, on a cross section of a composite solid electrolyte.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used in the disclosure have the same meaning as commonly understood by one of ordinary skill in the art to which the disclosure belongs. In addition, it will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Embodiments are described in the disclosure with reference to cross-sectional views which are schematic diagrams of idealized embodiments. As such, variations from the shapes of the illustrations as a result, for example, of manufacturing techniques and/or tolerances, are to be expected. Therefore, the embodiments described in the disclosure should not be construed as limited to the particular shapes regions of illustrated in the disclosure but may include deviations in shapes that result, for example, from manufacturing. For example, regions illustrated or described as being flat may be typically rough and/or have nonlinear features. Moreover, sharp-drawn angles may be round. Therefore, regions illustrated in the drawings are schematic in nature and their shapes are not intended to illustrate the actual shape of a region and are not intended to limit the scope of the claims.

The present inventive concept may, however, be embodied in different forms and should not be construed as limited to the embodiments described in the disclosure. These embodiments are provided so that the disclosure will be thorough and complete, and will fully convey the scope of the present inventive concept to those skilled in the art. Like reference numerals designate like elements.

When it is described that an element is “on” another element, it will be understood that the element may be disposed directly on another element or still another element may be interposed therebetween. On the other hand, when it is described that an element is “directly on” another element, still another element is not interposed therebetween.

It will be understood that, although the terms “first,” “second,” and “third” may be used herein to describe various elements, components, regions, layers, and/or sections, these elements, components, regions, layers, and/or sections should not be limited by these terms. These terms are only used to distinguish one element, component, region, layer, or section from another region, layer, or section. Therefore, a first element, component, region, layer, or section described below may be termed a second element, component, region, layer, or section without departing from the teachings of the present specification.

The term used herein is intended to describe only a specific embodiment and is not intended to limit the present inventive concept. As used herein, the singular forms “a,” “an,” and “the” are intended to include the plural forms, including “at least one,” unless the content clearly indicates otherwise. “At least one” should not be construed as being limited to the singular. As used herein, the term “and/or” includes any and all combinations of one or more of the associated listed items. The terms “includes,” “including,” “comprises,” and/or “comprising,” when used in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be used herein to easily describe one element or feature's relationship to another element or feature. It will be understood that the spatially relative terms are intended to encompass different orientations of a device in use or operation in addition to the orientation illustrated in the drawings. For example, when a device in the drawings is turned over, elements described as “below” or “beneath” other elements or features would then be “above” or “over” the other elements or features. Therefore, the example term “below” may encompass both orientations of above and below. The device may be otherwise oriented (rotated 90 degrees or at other orientations), and the spatially relative terms used herein may be interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

As used herein, “Group” refers to a group of the periodic table of elements according to the International Union of Pure and Applied Chemistry (“IUPAC”) Groups 1-18 group classification system.

As used herein, unless otherwise defined, the term “size” of particles refers to the “particle diameter” of particles.

As used herein, the term “particle diameter” of particles refers to an average diameter when particles are spherical and refers to an average major axis length when particles are non-spherical. A particle diameter of particles may be measured by using a particle size analyzer (PSA). A “particle diameter” of particles is, for example, an “average particle diameter.” The average particle diameter is a median particle diameter (D50) unless explicitly stated otherwise. The median particle diameter (D50) refers to a particle size corresponding to a 50% cumulative value when a particle size calculated from particles having the smallest particle size in a cumulative distribution curve of particle sizes in which particles are accumulated in order of particle sizes from the smallest particles to the largest particles. The cumulative value may be, for example, a cumulative volume. The median particle diameter (D50) may be measured, for example, through a laser diffraction method. Alternatively, an “average particle diameter” may be measured from a scanning electron microscope (SEM) image or a transmission electron microscopy (TEM) image through a manual or software method.

The term “metal” as used herein includes all of metals and metalloids such as silicon and germanium in an elemental or ionic state.

The term “alloy” as used herein refers to a mixture of two or more metals.

The term “cathode active material” as used herein refers to a cathode material that may undergo lithiation and delithiation.

The term “anode active material” as used herein refers to an anode material that may undergo lithiation and delithiation.

The terms “lithiate” and “lithiating” as used herein refer to a process of adding lithium to a cathode active material or an anode active material.

The terms “delithiate” and “delithiating” as used herein refer to a process of removing lithium from a cathode active material or an anode active material.

The terms “charge” and “charging” as used herein refer to a process of providing electrochemical energy to a battery.

The terms “discharge” and “discharging” as used herein refer to a process of removing electrochemical energy from a battery.

The terms “positive electrode” and “cathode” as used herein refer to an electrode at which electrochemical reduction and lithiation occur during a discharging process.

The terms “negative electrode” and “anode” as used herein refer to an electrode at which electrochemical oxidation and delithiation occur during a discharging process.

Hereinafter, a composite solid electrolyte and a secondary battery including the same according to an embodiment will be described in more detail.

### Composite Solid Electrolyte

A composite solid electrolyte according to an embodiment may include a first region, and a second region covering at least a portion of the first region. The first region may include an oxide solid electrolyte. The second region may include LiF. In the second region, a content of LiF at a surface side of the composite solid electrolyte is less than a content of LiF at an interface side between the first region and the second region. When a depth profile of the composite solid electrolyte is analyzed by X-ray photoelectron spectroscopy (XPS), the second region may include a 2-1 region having a content of LiF of about 23 atomic percent (at %) to about 40 at % based on a total 100 at % of the 2-1 region.

When the composite solid electrolyte includes the first region and the second region disposed on the first region, and the content of LiF at the interface side between the first region and the second region increases as compared with a surface side of the second region, an increase in interfacial resistance between the composite solid electrolyte and a cathode may be more effectively suppressed. When the content of LiF at the surface side of the second region is less, the flexibility at the surface side of the second region may be relatively increased as compared with the interface side between the first region and the second region. When the content of LiF at the surface side of the second region is less, an effective contact area between the cathode and the second region may be increased. An increase in interfacial resistance between the cathode and the composite solid electrolyte may be suppressed.

The content of LiF may be increased and a content of other components may be decreased at the interface side between the first region and the second region, ion transfer between the first region and the second region may be more effectively increased, and electron transfer between the first region and the second region may be more effectively suppressed. The growth of lithium dendrites between the first region and the second region may be more effectively suppressed. For example, in a secondary battery including a catholyte, when the content of LiF at the interface side between the first region and the second region is increased, the second region may more effectively block contact between the catholyte and the first region. When the first region includes the oxide solid electrolyte and the second region blocks contact between the catholyte and the oxide solid electrolyte, side reactions between the oxide solid electrolyte and the catholyte may be more effectively suppressed. As a result, the decomposition of the catholyte, for example, the decomposition of an ionic liquid, may be more effectively suppressed.

At the interface side between the first region and the second region, the content of LiF with relatively large ionic conductivity may increase, and the content of other components with relatively low ionic conductivity may decrease, thereby more effectively reducing the interfacial resistance between the first region and the second region.

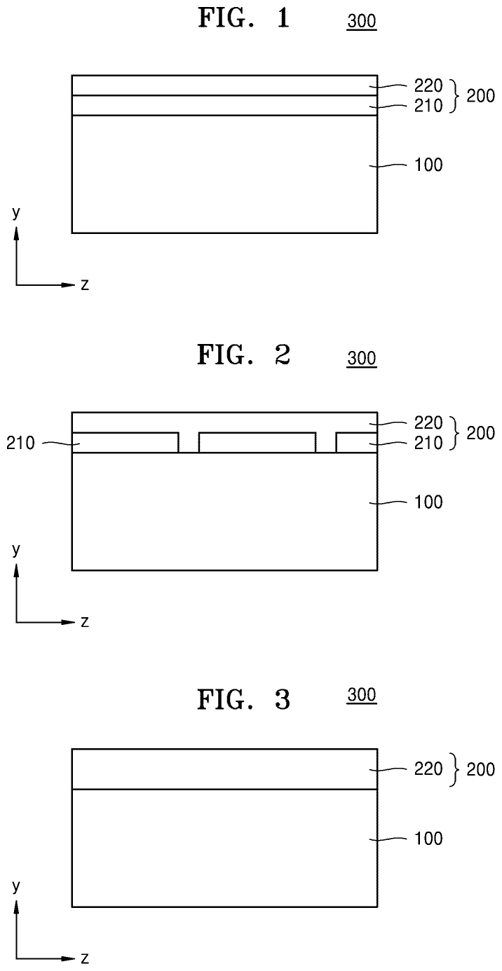

Referring to FIGS. 1 and 2, a composite solid electrolyte 300 may include a first region 100, and a second region 200 covering at least a portion of the first region 100. The first region 100 may include an oxide solid electrolyte, and the second region 200 may include LiF.

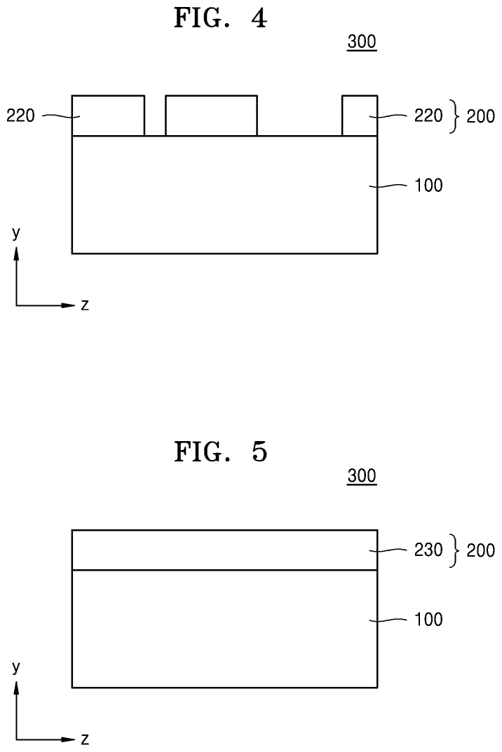

In the second region 200, a content of LiF at a surface side of the composite solid electrolyte 300 may be less than a content of LiF at an interface side between the first region 100 and the second region 200. The second region 200 may include a 2-1 region 210 having a content of LiF of 23 at % or greater, 24 at % or greater, or 25 at % or greater based on 100 at % of the 2-1 region 210. The second region 200 may include the 2-1 region 210 having a content of LiF of, for example, 40 at % or less, 37 at % or less, 35 at % or less, 33 at % or less, or 32 at % or less based on 100 at % of the 2-1 region 210. The second region 200 may include the 2-1 region 210 having a content of LiF of, for example, about 23 at % to about 40 at %, about 23 at % to about 37 at %, about 23 at % to about 35 at %, about 23 at % to about 33 at %, or about 23 at % to about 32 at % based on 100 at % of the 2-1 region 210. The presence of the 2-1 region 210 may be confirmed through, for example, XPS depth profile analysis. The composite solid electrolyte 300 may include the second region 200, and the second region 200 may include the 2-1 region 210, thereby blocking electron transfer between the composite solid electrolyte 300 and a cathode (not shown) and suppressing the formation of lithium dendrites. Accordingly, the cycle characteristics of a secondary battery including the composite solid electrolyte 300 may be improved. On the other hand, referring to FIG. 3, a composite solid electrolyte 300 may include a first region 100 and a second region 200, and the second region 200 may include a 2-2 region 220 and may not include a 2-1 region 210. In addition, referring to FIG. 4, a second region 200 including 2-2 regions 220 may be disposed in an island form at a portion of a first region 100. In the composite solid electrolytes 300 having the configurations of FIGS. 3 and 4, since the 2-1 region 210 is not included, the interfacial resistance between the composite solid electrolyte 300 and the cathode (not shown) may be excessively increased. As a result, the cycle characteristics of a secondary battery including the composite solid electrolyte 300 may deteriorate.

Referring to FIGS. 1 and 2, the second region 200 may include a 2-2 region 220 having a content of LiF of 10 at % or less, 5 at % or less, 3 at % or less, or 2 at % or less based on 100 at % of the 2-2 region 220. When the second region 200 includes the 2-2 region 220, the flexibility of the second region 200 may be improved. Accordingly, deterioration due to a change in volume during charging or discharging of a secondary battery including the composite solid electrolyte 300 may be suppressed, thereby improving the cycle characteristics of the secondary battery. The presence of the 2-2 region 220 may be confirmed through, for example, XPS depth profile analysis.

Referring to FIGS. 1 and 2, the 2-2 region 220 may be disposed closer to a surface of the composite solid electrolyte 300 than the 2-1 region 210. When the 2-2 region 220 is disposed closer to the surface of the composite solid electrolyte 300 than the 2-1 region 210, the durability of the composite solid electrolyte 300 may be improved. Since the mechanical strength of the 2-2 region 220 is less than that the mechanical strength of the 2-1 region 210, the composite solid electrolyte 300 may more stably accommodate a change in volume of the cathode during charging or discharging of a secondary battery.

Referring to FIGS. 1 and 2, in the second region 200, a content of LiF may increase in a direction (that is, a −y direction in FIGS. 1 and 2) from the surface side of the composite solid electrolyte 300 to the interface side between the first region 100 and the second region 200. The second region 200 may have a concentration gradient in which the content of LiF increases in the direction from the surface side of the composite solid electrolyte 300 to the interface side between the first region 100 and the second region 200. In the second region 200, the content of LiF may increase continuously or discontinuously in the direction from the surface side of the composite solid electrolyte 300 to the interface side between the first region 100 and the second region 200. The second region 200 may have a concentration gradient in which the content of LiF increases in the direction from the surface side of the composite solid electrolyte 300 to the interface side between the first region 100 and the second region 200, thereby reducing an abrupt change in composition between the cathode (not shown) and the oxide solid electrolyte of the first region 100. Thus, the second region 200 may more effectively suppress an increase in interfacial resistance between the cathode (not shown) and the oxide solid electrolyte of the first region 100. Accordingly, the cycle characteristics of a secondary battery including the composite solid electrolyte 300 may be further improved. In the second region 200, the content of LiF at the surface side of the composite solid electrolyte 300 may be, for example, 80% or less, 60% or less, 40% or less, or 20% or less of a content of LiF at the interface side between the first region 100 and the second region 200. The content of LiF may be measured through XPS depth profile analysis.

Referring to FIGS. 1 and 2, an area of the 2-1 region 210 may be, for example, 25% or more, 50% or more, 70% or more, 80% or more, or 90% or more of the total area of the second region 200. The area of the 2-1 region 210 may be, for example, about 25% to about 100%, about 50% to about 100%, about 70% to about 100%, about 80% to about 100%, or about 90% to about 100% of the total area of the second region 200. The area of the second region 200 and the area of the 2-1 region 210 may be areas when viewed in a direction of the surface (negative y, −y, direction) of the composite solid electrolyte 300 in FIGS. 1 and 2. When the 2-1 region 210 has an area in such a range, side reactions between a catholyte of the cathode (not shown) and the oxide solid electrolyte of the first region 100 may be more effectively blocked. When the area of the 2-1 region 210 is excessively small, it may be difficult to block side reactions between the catholyte of the cathode (not shown) and the oxide solid electrolyte of the first region 100.

Referring to FIGS. 1 and 2, the second region 200 may further include at least one non-metallic element selected from Groups 15 to 17 of the periodic table of elements. When the second region 200 further includes the non-metallic element, the flexibility of the second region 200 may be improved. On the other hand, referring to FIG. 5, in a composite solid electrolyte 300 including a first region 100 and a second region 200, wherein the second region 200 does not include a non-metallic element and is provided as a LiF layer 230 which is substantially homogeneous, a possibility of defects such as cracks occurring in the composite solid electrolyte 300 may increase due to a difference in volume change between the composite solid electrolyte 300 and a cathode (not shown) during a charging or discharging process. As a result, the cycle characteristics of a secondary battery including the composite solid electrolyte 300 may deteriorate.

Referring to FIGS. 1 and 2, in the composite solid electrolyte 300, the second region 200 may include the non-metallic element, and the non-metallic element may further include, for example, N, S, F, C, O, H, or a combination thereof.

In the second region 200, a content of the non-metallic element at the surface side of the composite solid electrolyte 300 may be greater than a content of the non-metallic element at the interface side between the first region 100 and the second region 200.

In the second region 200, the content of the non-metallic element at the surface side of the composite solid electrolyte 300 may be greater than the content of the non-metallic element at the interface side between the first region 100 and the second region 200, thereby more easily alleviating a pressure caused by a change in volume of the cathode (not shown).

The second region 200 may have a concentration gradient in which the content of the non-metal decreases in the direction (that is, the −y direction in FIGS. 1 and 2) from the surface side of the composite solid electrolyte 300 to the interface side between the first region 100 and the second region 200.

In the second region 200, the content of the non-metallic element may decrease continuously or discontinuously in the direction from the surface side of the composite solid electrolyte 300 to the interface side between the first region 100 and the second region 200. The second region 200 may have a concentration gradient in which the content of the non-metal decreases in the direction from the surface side of the composite solid electrolyte 300 to the interface side between the first region 100 and the second region 200, thereby reducing an abrupt change in composition between the cathode (not shown) and the oxide solid electrolyte of the first region 100. Thus, the second region 200 may more effectively suppress an increase in interfacial resistance between the cathode (not shown) and the oxide solid electrolyte of the second region 100. Accordingly, the cycle characteristics of a secondary battery including the composite solid electrolyte 300 may be further improved.

In the second region 200, the content of S and N at the surface side of the composite solid electrolyte 300 may be greater than the content of S and N at the interface side between the first region 100 and the second region 200. In the second region 200, the content of S and N at the surface side of the composite solid electrolyte 300 may be greater than the content of S and N at the interface side between the first region 100 and the second region 200, thereby more effectively suppressing an increase in interfacial resistance between the electrolyte 300 and the catholyte of the cathode (not shown). In the second region 200, the sum of the content of S and the content of N at the interface side between the first region 100 and the second region 200 may be, for example, 80% or less, 60% or less, 40% or less, or 20% or less of the sum of the content of S and the content of N at the surface side of the composite solid electrolyte 300. The content of N and S may each be measured through XPS depth profile analysis.

The second region 200 may further include, for example, Li₂S, Li₃N, LiNO₃, Li₂SO₄, LiOH, or a combination thereof. When the second region 200 further includes such a compound, the internal resistance of the second region 200 may be reduced, and the ionic conductivity of the second region 200 may be further improved. The interfacial resistance between the composite solid electrolyte 300 including the second region 200 and the cathode (not shown) may be further reduced. For example, the 2-1 region 210 may further include Li₂S, Li₃N, LiNO₃, Li₂SO₄, LiOH, or a combination thereof.

Referring to FIGS. 1 and 2, in the composite solid electrolyte 300, at a depth of 5 nanometers (nm) or more from the surface of the composite solid electrolyte 300, a ratio of the content of LiF to the total content of LiF, S, and N may be, for example, greater than 0.30, 0.40 or greater, 0.50 or greater, 0.60 or greater, 0.70 or greater, or 0.80 or greater. In the composite solid electrolyte 300, at a depth of 5 nm or more, 10 nm or more, 15 nm or more, or 20 nm or more from the surface of the composite solid electrolyte 300, the ratio of the content of LiF to the total content of LiF, S, and N may be, for example, greater than 0.30. For example, in a region which is closer to an interface between the first region 100 and the second region 200 than the surface of the composite solid electrolyte 300, the content of LiF may be relatively greater than the content of each of N and S. The ratio of the content of LiF may be measured, for example, through XPS depth profile analysis.

Referring to FIGS. 1 and 2, at the surface side of the composite solid electrolyte 300, that is, at a depth of less than 5 nm from the surface of the composite solid electrolyte 300, the ratio of the content of LiF to the total content of LiF, S, and N may be, for example, 0.20 or less, 0.15 or less, 0.10 or less, or 0.05 or less. That is, the content of LiF in a region adjacent to the surface of the composite solid electrolyte 300 may be relatively less than the content of each of N and S. The ratio of the content of LiF may be measured, for example, through XPS depth profile analysis.

Referring to FIGS. 1 and 2, a thickness of the second region 200 may be, for example, 100 nm or less, 80 nm or less, 60 nm or less, 40 nm or less, or 20 nm or less.

Referring to FIGS. 1 and 2, the thickness of the second region 200 may be, for example, about 1 nm to about 100 nm, about 1 nm to about 80 nm, about 1 nm to about 60 nm, about 1 nm to about 40 nm, or about 1 nm to about 20 nm.

When the second region 200 has a thickness in such a range, an excessive increase in interfacial resistance between the composite solid electrolyte 300 and the cathode (not shown) may be suppressed, and also, the precipitation of lithium dendrites and/or electron transfer between the composite solid electrolyte 300 and the cathode (not shown) may be effectively suppressed. As a result, the cycle characteristics of a secondary battery, which includes the composite solid electrolyte 300 including the second region 200, may be further improved.

Referring to FIGS. 1 and 2, the second region 200 may be a conformal coating layer that covers a portion or the entirety of a surface of the first region 100 along a surface contour of the first region 100.

When the second region 200 forms the conformal coating layer, an increased effective contact area may be provided between the composite solid electrolyte 300 and the cathode (not shown). Since the composite solid electrolyte 300 and the cathode (not shown) have an increased effective contact area, an increase in internal resistance of a secondary battery may be suppressed. As a result, the cycle characteristics of a secondary battery may be further improved.

Referring to FIGS. 1 and 2, the second region 200 may be a coating layer having a multi-layer structure. The second region 200 may include a first coating layer including the 2-1 region 210 and a second coating layer disposed on the first coating layer and including the 2-2 region 220. Although not shown in the drawings, for example, the first coating layer and the second coating layer may have a clear boundary or may not have a clear boundary. The composition and/or physical properties from the first coating layer to the second coating layer may be changed, for example, continuously or discontinuously. A boundary between the first coating layer and the second coating layer may be set, for example, according to the required composition and/or physical properties. For example, the boundary between the first coating layer and the second coating layer may be disposed in a region corresponding to a range of about 20% to about 80%, about 30% to about 70%, or about 40% to about 60% of the total thickness of the second region 200 with respect to half of the total thickness of the second region 200. The second region 200 may form the coating layer having the multi-layer structure, the cycle characteristics of a secondary battery, which includes the composite solid electrolyte 300 including the second region 200, may be further improved.

Referring to FIGS. 1 and 2, the 2-1 region 210 may include an inorganic layer including LiF, S, and N. When the 2-1 region 210 includes the inorganic layer, the structural stability of the 2-1 region 210 may be improved. The deterioration of the 2-1 region 210 may be suppressed despite a repeated change in voltage during a charging or discharging process of a secondary battery. On the other hand, since the organic layer is exposed to a high voltage during a charging or discharging process of a secondary battery, side reactions between the organic layer and the catholyte may be accelerated. As a result, the deterioration of the organic layer may be accelerated. The 2-2 region 220 may include, for example, an inorganic layer, an organic-inorganic composite layer, or a combination thereof.

The inorganic layer and the organic-inorganic composite layer may include, for example, LiF, S, and N.

The 2-2 region 220 may include, for example, an ionic liquid, a decomposition product of the ionic liquid, a fluorinated organic solvent, a decomposition product of the fluorinated organic solvent, a lithium salt, a decomposition product of the lithium salt, or a combination thereof.

When the 2-2 region 220 includes the ionic liquid, the decomposition product of the ionic liquid, the fluorinated organic solvent, the decomposition product of the fluorinated organic solvent, the lithium salt, the decomposition product of the lithium salt, or the combination thereof, the 2-2 region 220 may be, for example, an organic-inorganic composite layer. More detailed contents of the ionic liquid and the fluorinated organic solvent may be as defined in the part of a secondary battery below.

When the 2-2 region 220 is the organic-inorganic composite layer, the 2-2 region 220 may have increased flexibility as compared with an inorganic layer. For example, the organic-inorganic composite layer may have a reduced elastic modulus as compared with the inorganic layer.

When the organic-inorganic composite layer has increased flexibility as compared with the inorganic layer, the 2-2 region 220 including the organic-inorganic composite layer may more effectively accommodate a change in volume of the cathode (not shown) during charging or discharging of a secondary battery.

For example, the second region 200 may have a concentration gradient in which a content of the decomposition product of the ionic liquid, the fluorinated organic solvent, the decomposition product of the fluorinated organic solvent, the lithium salt, the decomposition product of the lithium salt, or the combination thereof decreases in a direction (for example, the −y direction in FIGS. 1 to 5) from a surface of the second region 200 to the interface between the second region 200 and the first region 100. For example, a content of the ionic liquid at a surface side of the second region 200 may be greater than a content of the ionic liquid at the interface side between the second region 200 and the first region 100. For example, a content of the fluorinated solvent at the surface side of the second region 200 may be greater than a content of the fluorinated solvent at the interface side between the second region 200 and the first region 100.

The first region 100 may include the oxide solid electrolyte.

Examples of the oxide solid electrolyte include lithium phosphorus oxynitride (LiPON), Li₃ₓLa_{(2/3-x)(1/3-2x)}TiO₃, wherein 0.04<x<0.16, Li₁₊ₓAlₓTi₂₋ₓ(PO₄)₃, wherein 0<x<2, Li₁₊ₓAlₓGe₂₋ₓ(PO₄)₃, wherein 0<x<2, Li_{1+x+y}AlₓTi₂₋ₓSi_{y}P_{3-y}O₁₂, wherein 0<x<2 and 0≤y<3, BaTiO₃, Pb(ZrₐTi₁₋ₐ)O₃, wherein 0≤a≤1, Pb₁₋ₓLaₓZr_{1-y}Ti_{y}O₃, wherein 0≤x<1 and 0≤y<1, Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃, wherein 0<x<2 and 0<y<3, LiₓAl_{y}Ti_{z}(PO₄)₃, wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂, wherein 0≤x≤1, 0≤y≤1, 0≤a≤1, and 0≤b≤1, LiₓLa_{y}TiO₃, wherein 0<x<2 and 0<y<3, Li₂O, LiOH, Li₂CO₃, LiAlO₂, Li₂O—Al₂O₃—SiO₂—P₂O₅—TiO₂—GeO₂, Li₃₊ₓLa₃M₂O₁₂, wherein M is Te, Nb, or Zr, and 1≤x≤10, Li₇La₃Zr₂O₁₂, Li₃₊ₓLa₃Zr₂₋ₐMₐO₁₂, wherein M is Ga, W, Nb, Ta, or Al, 0<a<2, and 1≤x≤10, or a combination thereof, but one or more embodiments are not limited thereto. Any material may be used as long as the material may be used as an oxide solid electrolyte in the art. The oxide solid electrolyte may be prepared, for example, through sintering or the like. The oxide solid electrolyte may be, for example, a garnet-type solid electrode selected from Li₇La₃Zr₂O₁₂ (LLZO) and Li₃₊ₓLa₃Zr₂₋ₐMₐO₁₂ (LLZO doped with M), wherein M is Ga, W, Nb, Ta, or Al, 0<a<2, and 1≤x≤10.

The oxide solid electrolyte may be, for example, crystalline, amorphous, glassy, or glass-ceramic. The oxide solid electrolyte may have various crystal states according to a preparation method and a composition.

A thickness of the first region 100 may be, for example, 500 micrometers (μm) or less, 200 μm or less, 100 μm or less, 80 μm or less, 70 μm or less, 60 μm or less, 50 μm or less, 40 μm or less, 30 μm or less, 20 μm or less, or 10 μm or less. The thickness of the first region 100 may be, for example, 1 μm or greater, 3 μm or greater, 5 μm or greater, 7 μm or greater, or 10 μm or greater. The thickness of the first region 100 may be for example, about 1 μm to about 500 μm, about 1 μm to about 200 μm, about 1 μm to about 100 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, or about 1 μm to about 10 μm. The thickness of the first region 100 may be, for example, about 10 μm to about 500 μm, about 10 μm to about 200 μm, about 10 μm to about 100 μm, about 10 μm to about 80 μm, about 10 μm to about 70 μm, about 10 μm to about 60 μm, or about 10 μm to about 50 μm. When the first region 100 has a thickness in such a range, the structural stability of a secondary battery including the composite solid electrolyte 300 may be improved, and the cycle characteristics of the secondary battery may be further improved.

### Secondary Battery

A secondary battery according to another embodiment may include a cathode, an anode, and an electrolyte layer disposed between the cathode and the anode. The electrolyte layer may include a composite solid electrolyte. The composite solid electrolyte may include a first region and a second region, and the second region may be disposed adjacent to the cathode.

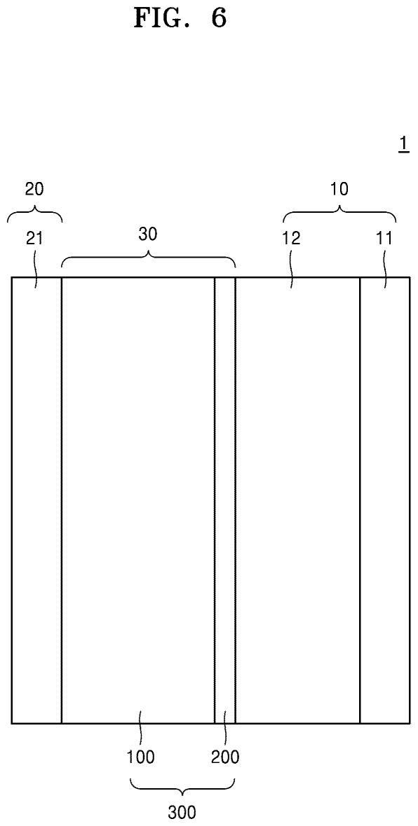

Referring to FIGS. 6 to 9, a secondary battery 1 or 1a may include a cathode 10, an anode, and an electrolyte layer 30 disposed between the cathode 10 and the anode 20. The electrolyte layer 30 may include a composite solid electrolyte 300. The composite solid electrolyte 300 may include a first region 100 and a second region 200, and the second region 200 may be disposed adjacent to the cathode 10. In the secondary battery 1 or 1a, due to the above-described composite solid electrolyte 300, an increase in interfacial resistance between the electrolyte layer 30 and the cathode 10 may be suppressed, the growth of lithium dendrites may be suppressed, and a short circuit of the electrolyte layer 30 may be suppressed. As a result, the cycle characteristics of the secondary battery 1 or 1a may be improved.

### Cathode

Referring to FIGS. 6 to 9, the secondary battery 1 or 1a may be, for example, an all-solid secondary battery, a semi-solid secondary battery, a hybrid secondary battery, or the like, but is not limited thereto. Any secondary battery may be used as long as the secondary battery may be used as the secondary battery 1 or 1a in the art. In the all-solid secondary battery, an electrolyte may be a solid. In the semi-solid secondary battery, an electrolyte may be a gel. In the hybrid secondary battery, an electrolyte may be a combination of a plurality of electrolytes in different states (for example, a combination of a solid electrolyte and a liquid electrolyte). The secondary battery 1 or 1a may be, for example, an alkaline metal secondary battery. The secondary battery 1 or 1a may be, for example, a lithium secondary battery.

### Cathode: Catholyte

The secondary battery 1 or 1a may include, for example, a cathode, and the cathode may include a catholyte. The catholyte may include, for example, a lithium salt, an ionic liquid, a fluorinated solvent, or a combination thereof. The catholyte may include, for example, a lithium salt and a fluorinated solvent. The catholyte may include, for example, a lithium salt, an ionic liquid, and a fluorinated solvent.

The catholyte may include an ionic liquid. When the catholyte includes the ionic liquid, high-voltage stability may be improved.

The catholyte may include the ionic liquid, and the ionic liquid may include, for example, a compound represented by Formula 1 or Formula 2:

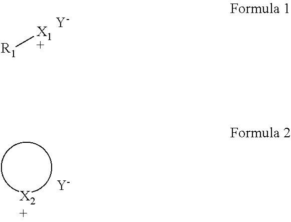

in Formula 1, X₁ may be —N(R₂)(R₃)(R₄) or —P(R₂)(R₃)(R₄), and R₁, R₂, R₃, and R₄ may each independently be an unsubstituted or halogen-substituted C1-C30 alkyl group, an unsubstituted or halogen-substituted C1-C30 alkoxy group, an unsubstituted or halogen-substituted C6-C30 aryl group. group, an unsubstituted or halogen-substituted C6-C30 aryloxy group, an unsubstituted or halogen-substituted C3-C30 heteroaryl group, an unsubstituted or halogen-substituted C3-C30 heteroaryloxy group, an unsubstituted or halogen-substituted C4-C30 cycloalkyl group, an unsubstituted or halogen-substituted C3-C30 heterocycloalkyl group, or an unsubstituted or halogen-substituted C2-C100 alkylene oxide group.

In Formula 2,

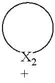

may be a heterocycloalkyl ring or heteroaryl ring including 1 to 3 heteroatoms and 2 to 30 carbon atoms, the ring may be unsubstituted or substituted with a substituent, X₂ may be —N(R₅)(R₆), —N(R₅)═, —P(R₅)(R₆), or —P(R₅)═, the substituent substituted in the ring, R5, and R6 may each independently be hydrogen, an unsubstituted or halogen-substituted C1-C30 alkyl group, an unsubstituted or halogen-substituted C1-C30 alkoxy group, an unsubstituted or halogen-substituted C6-C30 aryl group. group, an unsubstituted or halogen-substituted C6-C30 aryloxy group, an unsubstituted or halogen-substituted C3-C30 heteroaryl group, an unsubstituted or halogen-substituted C3-C30 heteroaryloxy group, an unsubstituted or halogen-substituted C4-C30 cycloalkyl group, an unsubstituted or halogen-substituted C3-C30 heterocycloalkyl group, or an unsubstituted or halogen-substituted C2-C100 alkylene oxide group. Y⁻ may be BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, BOB⁻(bis(oxalate)borate), CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

The catholyte may include an ionic liquid, and the ionic liquid may include, for example, a compound represented by Formula 3 or Formula 4 below:

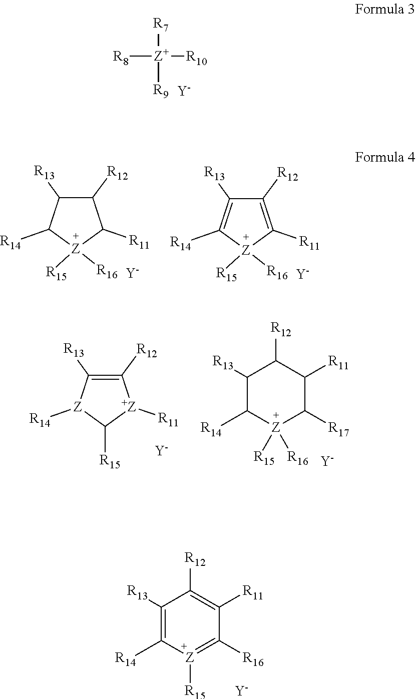

in Formula 3, Z may be N or P, and R₇, R₈, R₉ and R₁₀ may each independently be an unsubstituted or halogen-substituted C1-C30 alkyl group, an unsubstituted or halogen-substituted C6-C30 aryl group, an unsubstituted or halogen-substituted C3-C30 heteroaryl group, an unsubstituted or halogen-substituted C4-C30 cycloalkyl group, or an unsubstituted or halogen-substituted C3-C30 heterocycloalkyl group.

In Formula 4, Z may be N or P, R₁₁, R₁₂, R₁₃, R₁₄, R₁₅, R₁₆, and R₁₇ may each be independently hydrogen, an unsubstituted or halogen-substituted C1-C30 alkyl group, an unsubstituted or halogen-substituted C6-C30 aryl group, an unsubstituted or halogen-substituted C3-C30 heteroaryl group, an unsubstituted or halogen-substituted C4-C30 cycloalkyl group, or an unsubstituted or halogen-substituted C3-C30 heterocycloalkyl group. Y⁻ may be BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, BOB⁻(bis(oxalate)borate), CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

The catholyte may include an ionic liquid, and examples of the ionic liquid include 1-ethyl-1-methylimidazolium bis(fluorosulfonyl)imide, 1-methyl-1-propylpyrrolidinium bis(fluorosulfonyl)imide, 1-methyl-1-butylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, 1,3,5-trimethyl-1H-imidazol-3-ium bis(fluorosulfonyl)imide, or a combination thereof.

When the catholyte includes an ionic liquid, the disadvantages of a catholyte of a related art, such as side reactions between a cathode active material and the catholyte, the vaporization of the catholyte, and the like may be suppressed.

The catholyte may include a lithium salt, and examples of the lithium salt include LiPF₆, LiBF₄, LiCF₃SO₃, LiC₂F₅SO₃, LiC₄F₉SO₃, LiN(SO₂F)₂ (LiFSI), LiN(CF₃SO₂)₂ (LiTFSI), LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, compounds represented by Formulas 5 to 8, or a combination thereof.

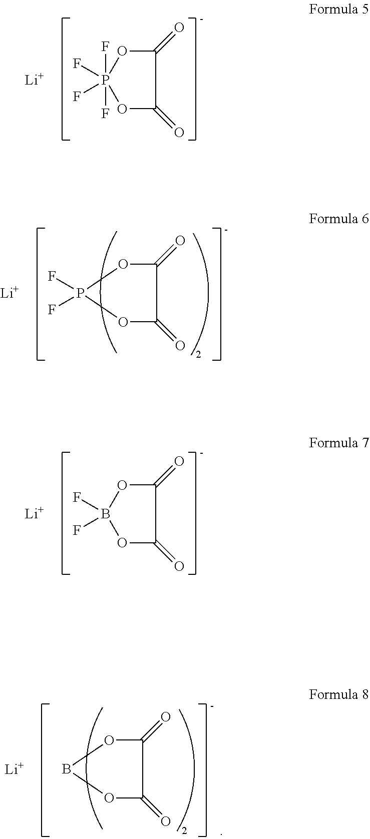

The catholyte may include the lithium salt, and a content of the lithium salt may be, for example, about 0.1 moles per liter (M) to about 5 M, about 0.5 M to about 3 M, or about 1 M to about 2.5 M. When the catholyte includes the lithium salt in such a range, the cycle characteristics of a secondary battery including the catholyte may be further improved.

The catholyte may include a fluorinated solvent. The fluorinated solvent may include a fluorinated carbonate-based solvent, a fluorinated ester-based solvent, a fluorinated ether-based solvent, or a combination thereof.

The fluorinated carbonate-based solvent may include a fluorinated cyclic carbonate-based solvent, a fluorinated chain carbonate-based solvent, or a combination thereof.

The fluorinated cyclic carbonate-based solvent may include, for example, a cyclic carbonate-based compound represented by Formula A below.

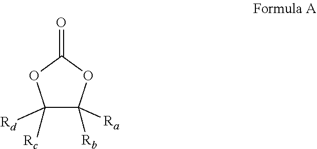

In Formula A, Rₐ, R_{b}, R_{c}, and R_{d} may each independently be a hydrogen atom, a fluorine atom, a C-C3 alkyl group, or a C1-C3 fluorinated alkyl group, wherein at least one of Rₐ, R_{b}, R_{c}, and R_{d} is a fluorine atom or a fluorinated alkyl group. The fluorinated alkyl group may be, for example, —CF₃, —CH₂F, —CHF₂, —CF₂CF₃, —CH₂CF₃, —CH₂CH₂F, or the like.

Examples of the fluorinated solvent include, 1-fluoroethylene carbonate, 1,1-difluoroethylene carbonate, 1,2-difluoroethylene carbonate, 1,1,2-trifluoroethylene carbonate, 1,1,2,2-tetrafluoroethylene carbonate, 1-trifluoromethylethylene carbonate, 1-fluoropropylene carbonate, or a combination thereof.

The fluorinated chain carbonate-based solvent may include, for example, a chain carbonate-based compound represented by Formula B below.

Rₑ—O—(C═O)—O—R_{f} Formula B

In Formula B, Rₑ and R_{f} may each independently be a C1-C10 alkyl group or a C1-C10 fluorinated alkyl group, wherein at least one of Rₑ and R_{f} is a fluorinated alkyl group. In the fluorinated alkyl group, some or all of hydrogen atoms of an alkyl group may be substituted with fluorine atoms.

The fluorinated solvent may include, for example, CF₃CH₂OCOOCH₂CF₃, CF₃CF₂CH₂OCOOCH₂CF₂CF₃, CF₃CF₂CH₂OCOOCH₃, CF₃CH₂OCOOCH₃, CF₃CH₂OCOOCH₃, CF₃CH₂OCOOCH₂CH₃, or a combination thereof.

The fluorinated ester-based solvent may include, for example, a compound represented by Formula C below.

R_{g}—(C═O)—O—Rₕ Formula C

In Formula C, R_{g} and Rₕ may each independently be a C2-C10 alkyl group or a C2-C10 fluorinated alkyl group, wherein at least one of R_{g} and Rₕ is a fluorinated alkyl group. In the fluorinated alkyl group, some or all of hydrogen atoms of an alkyl group may be substituted with fluorine atoms.

Examples of the fluorinated solvent include CF₃C(═O)OCH₂CF₃, CF₃C(═O)OCH₂CF₂CF₃, CF₃C(═O)OCH₂CF₂CF₂H, HCF₂C(═O)OCH₂CF₃, HCF₂C(═O)OCH₂CF₂CF₃, HCF₂C(═O)OCF₂CF₂H₂, CF₃C(═O)OCH₃, CF₃C(═O)OCH₂CH₃, HCF₂C(═O)OCH₃, HCF₂C(═O)OCH₂CH₃, CH₃CF₂C(═O)OCH₃, CH₃CF₂C(═O)OCH₂CH₃, CF₃CF₂C(═O)OCH₃, CF₃CF₂C(═O)OCH₂CH₃, CH₃C(═O)OCH₂CF₃, CH₃C(═O)OCH₂CF₂CF₃, CH₃C(═O)OCH₂CF₂CF₂H, CH₃CH₂C(═O)OCH₂CF₃, CH₃CH₂C(═O)OCH₂CF₂CF₃, CH₃CH₂C(═O)OCH₂CF₂CF₂H, or a combination thereof.

The fluorinated ether-based solvent may include, for example, a compound represented by Formula D or Formula E below.

Rᵢ—O—Rⱼ Formula D

In Formula B, Rᵢ and Rⱼ may each independently be a C1-C10 alkyl group or a C1-C10 fluorinated alkyl group, wherein at least one of Rᵢ and Rⱼ is a fluorinated alkyl group.

In the fluorinated alkyl group, some or all of hydrogen atoms of an alkyl group may be substituted with fluorine atoms.

Examples of the fluorinated solvent include HCF₂CF₂CH₂OCF₂CF₂H, CF₃CF₂CH₂OCF₂CF₂H, HCF₂CF₂CH₂OCF₂CFHCF₃, CF₃CF₂CH₂OCF₂CFHCF₃, HCF₂CF₂CH₂OCH₂CFHCF₃, CF₃CF₂CH₂OCH₂CFHCF₃, or a combination thereof.

N≡C—Rₖ—O—Rₗ Formula E

In Formula E, Rₖ may be a C1-C10 alkylene group or a C1-C10 fluorinated alkylene group, and Rₗ may be a C1-C10 alkyl group or a C1-C10 fluorinated alkyl group, wherein at least one of Rₖ and Rₗ includes fluorine. In the fluorinated alkyl group and the fluorinated alkylene group, some or all of hydrogen atoms of each of an alkyl group and an alkylene group may be substituted with fluorine atoms.

Examples of the fluorinated solvent include 3-(2,2,3,3-tetrafluoropropoxy)propanenitrile, 3-(2,2,3,3,3-pentafluoropropoxy)propanenitrile, 3-(2,2,3,3-tetrafluoropropoxy)propanenitrile, 3-(2,2,3,3-tetrafluoropropoxy)propanenitrile, 3-(2,2,3,3-tetrafluoropropoxy)propanenitrile, 3-(2,2,3,3-tetrafluoropropoxy)propanenitrile, 3-(2,2,3,3-tetrafluoropropoxy)propanenitrile, or a combination thereof.

When the catholyte includes the fluorinated solvent, a viscosity of the catholyte may be lowered. Since the viscosity of the catholyte is lowered, the catholyte may be more easily impregnated into a cathode active material layer and may provide improved ionic conductivity. A viscosity of the fluorinated solvent may be 95% or less, 90% or less, 85% or less, or 80% or less of a viscosity of the ionic liquid.

The catholyte may further include, for example, a polymer binder, an oligomer binder, or the like. The catholyte may further include, for example, an oligomer with a molecular weight of 1,000 Dalton or more, a polymer with a molecular weight of 1,000 Dalton or more, or a combination thereof. When the catholyte includes the polymer, the oligomer, or the like which is used as a binder, the structural stability of the cathode may be improved.

The catholyte may further include, for example, a non-aqueous solvent. The catholyte may further include a non-aqueous solvent such as a hydrocarbon-based solvent, an ether-based solvent, or a carbonate-based solvent. When the catholyte further includes the non-aqueous solvent, the viscosity of the catholyte may be easily adjusted.

The catholyte may further include, for example, an inorganic solid electrolyte. The catholyte may further include an inorganic solid electrolyte in addition to the organic electrolyte described above. The catholyte may further include, for example, an inorganic solid electrolyte such as a sulfide solid electrolyte, an oxide solid electrolyte, or a halide solid electrolyte. When the catholyte further includes the inorganic solid electrolyte, the structural stability of the cathode may be improved.

### Cathode: Cathode Active Material Layer

Referring to FIGS. 6 to 9, the cathode 10 may include a cathode current collector 11 and a cathode active material layer 12 disposed on one side of the cathode current collector 11. The cathode active material layer 12 may include a cathode active material.

Any material may be used as the cathode active material without limitation as long as the material may be commonly used in lithium batteries. For example, the cathode active material may include a lithium transition metal oxide, a transition metal sulfide, or the like. For example, at least one composite oxide of lithium and a metal selected from cobalt, manganese, nickel, and a combination thereof may be used. A specific example of the cathode active material may include a compound represented by any one of formulas of LiₐA_{1-b}B′_{b}D₂, wherein 0.90≤a≤1.8 and 0≤b≤0.5; LiₐE_{1-b}B′_{b}O_{2-c}D_{c}, wherein 0.90≤a≤1.8, 0≤b≤0.5, and 0≤c≤0.05; LiE_{2-b}B′_{b}O_{4-c}D_{c}, 0≤b≤0.5 and 0≤c≤0.05; LiₐNi_{1-b-c} Co_{b}B′_{c}D_{α}, wherein 0.90≤a≤1.8, 0≤b≤0.5, 0≤c≤0.05, and 0<α≤2; LiₐNi_{1-b-c}Co_{b}B′_{c}O_{2-α}F′_{α}, wherein 0.90≤a≤1.8, 0≤b≤0.5, 0≤c≤0.05, and 0<a<2; LiₐNi_{1-b-c}Co_{b}B′_{c}O_{2-α}F′_{α}, wherein 0.90≤a≤1.8, 0≤b≤0.5, 0≤c≤0.05, and 0<α<2; LiₐNi_{1-b-c}Mn_{b}B′_{c}D_{α}, wherein 0.90≤a≤1, ≤b≤0.5, 0≤c≤0.05, and 0<α≤2; LiₐNi_{1-b-c}Mn_{b}B′_{c}O_{2-α}F′_{α}, wherein 0.90≤a≤1.8, 0≤b≤0.5, 0≤c≤0.05, and 0<a<2; LiₐNi_{1-b-c}Mn_{b}B′_{c}O_{2-α}F′_{α}, wherein 0.90≤a≤1.8, 0≤b≤0.5, 0≤c≤0.05, and 0<α<2; LiₐNi_{b}E_{c}G_{d}O₂, wherein 0.90≤a≤1.8, 0≤b≤0.9, and 0≤c≤0.5, and 0.001≤d≤0.1; LiₐNi_{b}Co_{c}Mn_{d}GeO₂, wherein 0.90≤a≤1.8, 0≤b≤0.9, 0≤c≤0.5, 0≤d≤5, and 0.001≤e≤0.1; LiₐNiG_{b}O₂, wherein 0.90≤a≤1.8 and 0.001≤b≤0.1; LiₐCoG_{b}O₂, wherein 0.90≤a≤1.8 and 0.001≤b≤0.1; LiₐMnG_{b}O₂, wherein 0.90≤a≤1.8 and 0.001≤b≤0.1; LiₐMn₂GbO₄, wherein 0.90≤a≤1.8 and 0.001≤b≤0.1; QO₂; QS₂; LiQS₂; V₂O₅; LiV₂O₂; LiI′O₂; LiNiVO₄; Li_{(3-f)} J₂(PO₄)₃; wherein 0≤f≤2, Li_{(3-f)}Fe₂(PO₄)₃, wherein 0≤f≤2; or LiFePO₄. In the above formulas, A may be Ni, Co, Mn, or a combination thereof; B′ may be Al, Ni, Co, Mn, Cr, Fe, Mg, Sr, V, a rare earth element, or a combination thereof; D may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof. For example, LiCoO₂, LiMnₓO₂ₓ, wherein x=1 or 2, LiNi₁₋ₓMnₓO₂ₓ, wherein 0<x<1, Ni_{1-x-y}CoₓMn_{y}O₂, wherein 0≤x≤0.5 and 0<y≤0.5, LiFePO₄, TiS₂, FeS₂, TiS₃, FeS₃, or the like may be used.

For example, the cathode active material may be one of the compounds represented by the Formulas 9 to 16 below:

LiₐCOₓM_{y}O_{2-b}A_{b} Formula 9

in Formula 9, 1.0≤a≤1.2, 0≤b≤0.2, 0.9≤x≤1, 0<y≤0.1, x+y=1, M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, S, Cl, Br, or a combination thereof,

LiₐNiₓCo_{y}M_{z}O_{2-b}A_{b} Formula 10

in Formula 10, 1.0≤a≤1.2, 0≤b≤0.2, 0.8<x<1, 0<y≤0.3, 0<z≤0.3, x+y+z=1, M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, S, Cl, Br, or a combination thereof,

LiNiₓCo_{y}Mn_{z}O₂, Formula 11

LiNiₓCo_{y}Al_{z}O₂ Formula 12

in Formula 11 and Formula 12, 0.8≤x≤0.95, 0<y≤0.2, 0<z≤0.2, and x+y+z=1,

LiNiₓCo_{y}Mn_{z}Al_{w}O₂ Formula 13

in Formula 13, 0.8≤x≤0.95, 0<y≤0.2, 0<z≤0.2, 0<w≤0.2, and x+y+z+w=1,

LiₐNiₓMn_{y}M′_{z}O_{2-b}A_{b} Formula 14

in Formula 14, 1.0≤a≤1.2, 0≤b≤0.2, 0<x≤0.3, 0.5≤y<1, 0<z≤0.3, x+y+z=1, M′ may be cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, S, Cl, Br, or a combination thereof,

LiₐM1ₓM2_{y}PO_{4-b}X_{b} Formula 15

in Formula 15, 0.90≤a≤1.1, 0≤x≤0.9, 0<y≤0.5, 0.9<x+y<1.1, 0≤b≤2, M1 may be chromium (Cr), manganese (Mn), iron (Fe), cobalt (Co), nickel (Ni), copper (Cu), zirconium (Zr), or a combination thereof, M2 may be magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X may be O, F, S, P, or a combination thereof, or

LiₐM3_{z}PO₄ Formula 16

in Formula 16, 0.90≤a≤1.1, 0.9≤z≤1.1, and M3 may be chromium (Cr), manganese (Mn), iron (Fe), cobalt (Co), nickel (Ni), copper (Cu), zirconium (Zr), or a combination thereof.

The cathode active material layer 12 may further include a conductive material and a binder.

The conductive material may include, for example, carbon black (CB), carbon fiber, graphite, or a combination thereof. The CB may be, for example, acetylene black (AB), Ketjen black (KB), super P carbon, channel black, furnace black (FB), lamp black, thermal black, or a combination thereof. The graphite may be natural graphite or artificial graphite. A combination including at least one of the above-described materials may be used. The cathode 10 may additionally include additional conductive agents in addition to a carbonaceous conductive agent described above. The additional conductive agents may include an electrically conductive fiber such as metal fiber; a fluorinated carbon powder or a metal powder such as an aluminum powder or a nickel powder; conductive whisker such as zinc oxide or potassium titanate; or a polyethylene derivative. A combination including at least one of the above-described additional conductive agents may be used. A content of the conductive material may be about 1 part by weight to about 10 parts by weight or about 2 parts by weight to about 7 parts by weight with respect to 100 parts by weight of the cathode active material. When an amount of the conductive material is in such a range, for example, about 1 part by weight to about 10 parts by weight, the electrical conductivity of the cathode 10 may be adequate.

The binder may improve an adhesive force between components of the cathode 10 and an adhesive force of the cathode 10 with respect to a current collector. Examples of the binder include polyacrylic acid (PAA), polyvinylidene fluoride (PVDF), polyvinyl alcohol, carboxymethyl cellulose (CMC), starch, hydroxypropyl cellulose, regenerated cellulose, polyvinylpyrrolidone, tetrafluoroethylene, polyethylene, polypropylene, an ethylene-propylene-diene monomer, (EPDM), a sulfonated) EPDM, styrene-butadiene-rubber (SBR), fluorinated rubber, a copolymer thereof, or a combination thereof. A content of the binder may be about 1 part by weight to about 10 parts by weight or about 2 parts by weight to about 7 parts by weight with respect to 100 parts by weight of the cathode active material. When the content of the binder is in such a range, an adhesive force of the cathode active material layer 12 with respect to the cathode current collector 11 may be further improved, and a decrease in energy density of the cathode active material layer 12 may be suppressed.

### Cathode: Cathode Current Collector

The cathode 10 may include the cathode current collector 11. The cathode current collector 11 may be omitted.

The cathode current collector 11 may include, for example, a metal substrate. The metal substrate may include a plate, foil, or the like including, for example, aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. The cathode current collector 11 may be omitted. The cathode current collector 11 may further include a carbon layer (not shown) disposed on one side or two sides of the metal substrate. The carbon layer may be additionally disposed on the metal substrate so that a metal of the metal substrate may be prevented from being corroded by a solid electrolyte included in the cathode 10, and the interface resistance between the cathode active material layer 12 and the cathode current collector 11 may be reduced. A thickness of the carbon layer may be, for example, about 0.1 μm to about 5 μm, about 0.1 μm to about 3 μm, or about 0.1 μm to about 1 μm. When the carbon layer is excessively thin, it may be difficult to completely block contact between the metal substrate and the solid electrolyte. When the carbon layer is excessively thick, the energy density of an all-solid secondary battery may decrease. The carbon layer may include amorphous carbon, crystalline carbon, and the like.

### Electrolyte Layer

Referring to FIGS. 6 to 9, the solid lithium battery 1 or 1a may include the electrolyte layer 30, and the electrolyte layer 30 may include the composite solid electrolyte 300.

The electrolyte layer 30 may be, for example, impermeable to a liquid. Therefore, the catholyte may not penetrate the electrolyte layer 30.

The electrolyte layer 30 may include, for example, an oxide solid electrolyte, a sulfide solid electrolyte, a halide solid electrolyte, or a combination thereof. The electrolyte layer 30 may have, for example, a single-layer structure or a multi-layer structure. At least one solid electrolyte of the above-described oxide solid electrolyte, sulfide solid electrolyte, or halide solid electrolyte may be disposed in one layer or a plurality of layers constituting the electrolyte layer 30.

The oxide solid electrolyte may be defined as for the above-described composite solid electrolyte.

The sulfide solid electrolyte may include, for example, lithium sulfide, silicon sulfide, phosphorus sulfide, boron sulfide, or a combination thereof. Sulfide solid electrolyte particles may include Li₂S, P₂S₅, SiS₂, GeS₂, B₂S₃, or a combination thereof. The sulfide solid electrolyte particles may include Li₂S or P₂S₅. The sulfide solid electrolyte particles are known to have greater lithium ion conductivity than other inorganic compounds. For example, the sulfide solid electrolyte may include Li₂S and P₂S₅. When a sulfide solid electrolyte material constituting a solid electrolyte includes Li₂S—P₂S₅, a mixing molar ratio of Li₂S to P₂S₅ may be, for example, about 50:50 to about 90:10. In addition, the sulfide solid electrolyte may include an inorganic solid electrolyte which is prepared by adding Li₃PO₄, a halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“Thio LISICON”), Li₂O—Al₂O₃—TiO₂—P₂O₅(“LATP”), or the like to Li₂S—P₂S₅, SiS₂, GeS₂, B₂S₃, or a combination. Non-limiting examples of the sulfide solid electrolyte material include Li₂S—P₂S₅; Li₂S—P₂S₅—LiX, wherein X is a halogen element (e.g., F, Cl, Br, I, or a combination thereof); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ, wherein m and n are each a positive number and Z is Ge, Zn, or Ga; Li₂S—GeS₂; Li₂S—SiS₂—Li₃PO₄; and Li₂S—SiS₂—LiₚMO_{q}, wherein p and q are each a positive number and M is P, Si, Ge, B, Al, Ga, or In. In this regard, the sulfide solid electrolyte material may be prepared by treating a raw starting material (for example, Li₂S or P₂S₅) of the sulfide solid electrolyte material through melt quenching, mechanical milling, or the like. In addition, a calcination process may be performed after the treating.

The halide solid electrolyte may include, for example, a halogen element as a main component of anions. Including the halogen element as a main component of anions means that a ratio (molar ratio) of the halogen element is the greatest among all the anions constituting the halide solid electrolyte. A ratio of a halogen (X) element to the total of all anions constituting the halide solid electrolyte may be, for example, 50 mole percent (mol %) or greater, 70 mol % or greater, 90 mol % or greater, or 100 mol %. There may be at least one halogen element. The halide solid electrolyte may not include, for example, a sulfur element (S element). The halide solid electrolyte may include, for example, a Li element, an M element, wherein M is a metal other than Li, and an X element. X may be, for example, F, Cl, Br, I, or a combination thereof. The halide solid electrolyte may include, for example, Br or Cl as X. As M, the halide solid electrolyte may include, for example, a metal element such as Sc, Y, B, Al, Ga, or In. A composition of the halide solid electrolyte may be represented by, for example, Li₆₋₃ₐMₐBr_{b}Cl_{c}, wherein M is a metal other than Li, 0<a<2, 0≤b≤6, 0≤c≤6, and b+c=6. The halide solid electrolyte may include, for example, Li₃YBr₆, Li₃YCl₆, Li₃YBr₂C₁₄, or the like. The halide solid electrolyte may be, for example, a particulate. An average particle diameter (D50) of the halide solid electrolyte may be, for example, of about 0.05 μm to about 50 μm or about 0.1 μm to about 20 μm. The average particle diameter (D50) of the halide solid electrolyte may be measured using, for example, a laser diffraction particle size distribution meter or a SEM.

The electrolyte layer 30 may be provided, for example, in the form of a composite solid electrolyte 300 sheet or a composite solid electrolyte 300 thin film. The composite solid electrolyte 300 may include a first region 100 and a second region 200, wherein the first region 100 includes an oxide solid electrolyte, and the second region 200 includes LiF. The second region 200 of the composite solid electrolyte 300 may be disposed adjacent to the cathode 10.

Alternatively, the electrolyte layer 30 may be prepared by mixing the above-described solid electrolyte with other components. The electrolyte layer 30 may be prepared, for example, by mixing and drying the above-described solid electrolyte and a binder or by pressing and/or sintering the above-described solid electrolyte powder in a certain form. The electrolyte layer 30 may be prepared, for example, by mixing and drying a sulfide, oxide and/or halide solid electrolyte, and a binder or by pressing and/or sintering a sulfide, oxide, and/or halide solid electrolyte powder in a certain form.

The electrolyte layer 30 may be deposited on the cathode 10 or an anode 20 by using a film formation method such as blasting, aerosol deposition, cold spraying, sputtering, chemical vapor deposition (CVD), or spraying, and thus a solid electrolyte layer may be prepared. The electrolyte layer 30 may be formed, for example, by pressing a solid electrolyte. The electrolyte layer 30 may be formed by mixing and pressing a solid electrolyte, a solvent, and a binder or support. In this case, the solvent or support may be added to reinforce the strength of the solid electrolyte layer or prevent a short circuit of the solid electrolyte.

The binder included in the electrolyte layer 30 may include, for example, SBR, polytetrafluoroethylene (PTFE), PVDF, polyethylene, polyvinyl alcohol, or the like, but one or more embodiments are not limited thereto. Any material may be used as long as the material may be used as a binder in the art. The binder of the electrolyte layer 30 may be the same as or different from a binder of the cathode 10 and/or the anode 20.

A thickness of the electrolyte layer 30 may be, for example, 500 μm or less, 300 μm or less, 100 μm or less, or 50 μm or less. The thickness of the electrolyte layer 30 may be, for example, about 1 μm to about 500 μm, about 5 μm to about 300 μm, about 10 μm to about 100 μm, or about 10 μm to about 50 μm.

### Anode: Anode Active Material Layer

Referring to FIGS. 6 to 9, the secondary battery 1 or 1a may include the anode 20, and the anode 20 may include an anode current collector 21 or may include the anode current collector 21 and an anode active material layer 23.

The anode 20 may be thinner than the cathode 10. A thickness of the anode 20 may be, for example, 90% or less, 80% or less, 60% or less, or 50% or less of a thickness of the cathode 10.

The anode active material layer 23 may include, for example, lithium foil, a lithium powder, a precipitated lithium, a lithium alloy, or a combination thereof. The anode active material layer 23 may be, for example, a lithium metal layer. The anode active material layer 23 may be prepared by coating an anode current collector with a slurry including a lithium powder, a binder, and the like. The binder may be, for example, a fluorinated binder such as PVDF. The anode active material layer 23 may include a metal-based anode active material. The anode active material layer 23 may also be a precipitated lithium metal layer. Examples of the lithium alloy include a Li—Al alloy, a Li—Sn alloy, a Li—In alloy, a Li—Ag alloy, a Li—Au alloy, a Li—Zn alloy, a Li—Ge alloy, a Li—Si alloy, or the like, but one or more embodiments are not limited thereto. Any material may be used as long as the material is used as a lithium alloy in the art.

A thickness of the anode active material layer 23 may have, for example, about 0.1 μm to about 100 μm, about 0.1 μm to about 80 μm, about 1 μm to about 80 μm, or about 10 μm to about 80 μm, but one or more embodiments are not necessarily limited to such a range. The thickness of the anode active material layer 23 may be adjusted according to the required shape, capacity, or the like of a secondary battery. When the thickness of the anode active material layer 23 excessively increases, the structural stability of a secondary battery may deteriorate, and side reactions may increase. When the thickness of the anode active material layer 23 excessively decreases, the energy density of a secondary battery may decrease. A thickness of the lithium foil may be, for example, about 1 μm to about 50 μm, about 1 μm to about 30 μm, about 10 μm to about 30 μm, or about 10 μm to about 80 μm. When the lithium foil has a thickness in such a range, the lifespan characteristics of a secondary battery including anode active material layer 23 may be further improved. A particle diameter of the lithium powder may be, for example, about 0.1 μm to about 3 μm, about 0.1 μm to about 2 μm, or about 0.1 μm to about 1 μm. When the lithium powder has a thickness in such a range, it is possible to further improve the lifespan characteristics of a lithium battery including anode active material layer 23. A thickness of the precipitated lithium metal layer may be, for example, about 1 μm to about 80 μm or about 10 μm to about 80 μm.

### Anode: Anode Current Collector

Referring to FIGS. 6 to 9, the anode 20 may include the anode current collector 21.

The anode current collector 21 may include, for example, a first metal substrate. The first metal substrate may include a first metal as a main component or may include the first metal. A content of the first metal included in the first metal substrate may be, for example, 90 weight percent (wt %) or greater, 95 wt % or greater, 99 wt % or greater, or 99.9 wt % or greater with respect to the total weight of the first metal substrate. The first metal substrate may include, for example, a material that does not react with lithium, for example, a material that does not form an alloy and/or compound with lithium. Examples of the first metal include copper (Cu), nickel (Ni), stainless steel (SUS), iron (Fe), or cobalt (Co), but one or more embodiments are not necessarily limited thereto. Any material may be used as long as the material may be used as a current collector in the art. The metal substrate may include, for example, one of the above-described metals or an alloy of two or more metals. The first metal substrate may be, for example, in the form of a sheet or foil. A thickness of the anode current collector 21 may be, for example, about 5 μm to about 50 μm, about 10 μm to about 50 μm, about 10 μm to about 40 μm, or about 10 μm to about 30 μm, but is not necessarily limited to such a range. The thickness of the anode current collector 21 may be selected according to the required characteristics of a lithium battery.

The anode current collector 21 may further include a coating layer (not shown), which includes a second metal disposed on the first metal substrate.

The anode current collector 21 may include, for example, the first metal substrate, and the coating layer disposed on the first metal substrate and including the second metal. The second metal has a greater Mohs hardness than the first metal. For example, the coating layer including the second metal may be harder than a substrate including the first metal, and thus the deterioration of the first metal substrate may be prevented. A material constituting the first metal substrate may have, for example, a Mohs hardness of 5.5 or less. The first metal may have, for example, a Mohs hardness of 5.5 or less, 5.0 or less, 4.5 or less, 4.0 or less, 3.5 or less, or 3.0 or less. The first metal may have, for example, a Mohs hardness of about 2.0 to about 6.0. The coating layer may include the second metal. The coating layer may include, for example, the second metal as a main component or may include the second metal. A content of the second metal included in the coating layer may be, for example, 90 wt % or greater, 95 wt % or greater, 99 wt % or greater, or 99.9 wt % or greater with respect to the total weight of the coating layer. The coating layer may include, for example, a material that does not react with lithium, for example, a material that does not form an alloy and/or compound with lithium. A material constituting the coating layer may have, for example, a Mohs hardness of 6.0 or greater. For example, the second metal may have a Mohs hardness of 6.0 or greater, 6.5 or greater, 7.0 or greater, 7.5 or greater, 8.0 or greater, 8.5 or greater, or 9.0 or greater. The second metal may have, for example, a Mohs hardness of about 6.0 to about 12. When the Mohs hardness of the second metal is excessively low, it may be difficult to suppress the deterioration of the anode current collector 21. When the Mohs hardness of the second metal is excessively large, processing may be more challenging. The second metal may include, for example, titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), rhodium (Rh), or a combination thereof. The coating layer may include, for example, one of the above-described metals or an alloy of two or more metals. A difference in Mohs hardness between the first metal included in the first metal substrate and the second metal included in the coating layer may be, for example, 2 or greater, 2.5 or greater, 3 or greater, 3.5 or greater, or 4 or greater. The first metal and the second metal may have such a difference in Mohs hardness, and thus the deterioration of the anode current collector 21 may be more effectively suppressed. The coating layer may have a single-layer structure or a multi-layer structure including two or more layers. The coating layer may have, for example, a two-layer structure including a first coating layer and a second coating layer. The coating layer may have, for example, a three-layer structure including a first coating layer, a second coating layer, and a third coating layer. A thickness of the coating layer may be, for example, about 10 nm to about 1 μm, about 50 nm to about 500 nm, about 50 nm to about 200 nm, or about 50 nm to about 150 nm. When the coating layer is excessively thin, it may be difficult to suppress the non-uniform growth of a lithium-containing metal layer. As the thickness of the coating layer increases, the cycle characteristics of a lithium battery may be improved. However, when the coating layer is excessively thick, the energy density of the lithium battery may decrease, and it may not be easy to form the coating layer. The coating layer may be disposed on the first metal substrate through, for example, vacuum deposition, sputtering, plating, or the like, but one or more embodiments are not necessarily limited to such a method. Any method capable of forming a coating layer in the art may be used.

### Anode: First Interlayer (not Shown)

Although not shown in FIGS. 6 to 9, the anode 20 may further include a first interlayer disposed between the anode current collector 21 and the electrolyte layer 30. When the anode 20 includes the first interlayer, the formation and/or growth of lithium dendrites in the anode 20 may be more effectively suppressed. The first interlayer may be omitted. The first interlayer may be thinner than, for example, the electrolyte layer 30 or the cathode 10.

The first interlayer may include, for example, an anolyte.

The anolyte may be, for example, an organic electrolyte solution. The organic electrolyte solution may be prepared by dissolving a lithium salt, for example, in an organic solvent.

As the organic solvent, any material may be used as long as the material may be used as an organic solvent in the art. Examples of the organic solvent include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or a mixture thereof.

As the lithium salt, any material may be used as long as the material may be used as a lithium salt in the art. Examples of the lithium salt include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂), wherein 1≤x≤20 and 1≤y≤20, LiCl, LiI, or a mixture thereof. A concentration of the lithium salt may be, for example, about 0.1 M to about 5.0 M.

The first interlayer may include, for example, a separator and an anolyte impregnated in the separator.

As the separator, any separator may be used as long as the separator is commonly used in a lithium battery. For example, a separator having low resistance to the movement of ions in an electrolyte and an excellent electrolyte impregnation ability may be used. For example, the separator may include glass fiber, polyester, Teflon, polyethylene, polypropylene, PTFE, or a combination thereof and may be in the form of a nonwoven fabric or a woven fabric. For example, a windable separator including polyethylene, polypropylene, or the like may be used in a lithium ion battery, and a separator having an excellent electrolyte impregnation ability may be used in a lithium ion polymer battery.

The separator may be prepared through the following exemplary method, but one or more embodiments are not necessarily limited to such a method. A method may be adjusted according to required conditions.

First, a polymer resin, a filler, and a solvent may be mixed to prepare a separator composition. The separator composition may be applied directly onto an electrode and dried to form the separator. Alternatively, the separator composition may be cast on a support, and then a separator film peeled off the support may be laminated on an electrode to form the separator.

A polymer used for preparing the separator is not necessarily limited, and any polymer may be used as long as the polymer may be used in a binding material of an electrode plate. For example, the polymer may include a vinylidene fluoride/hexafluoropropylene copolymer, PVDF, polyacrylonitrile, polymethyl methacrylate, or a mixture thereof.

### Anode: Second Interlayer

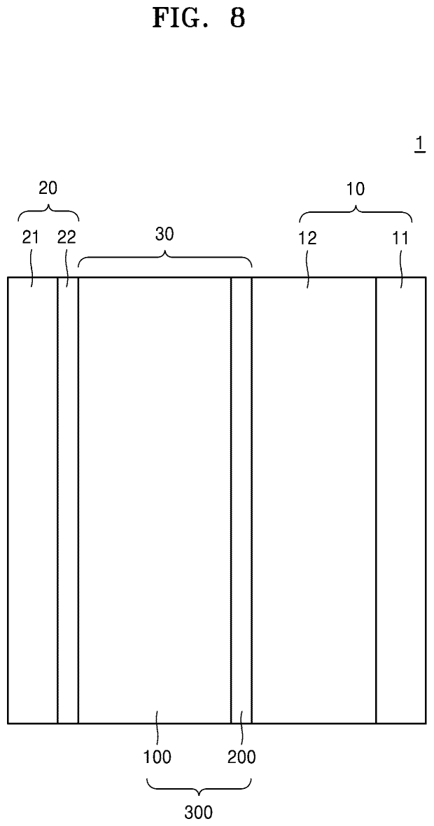

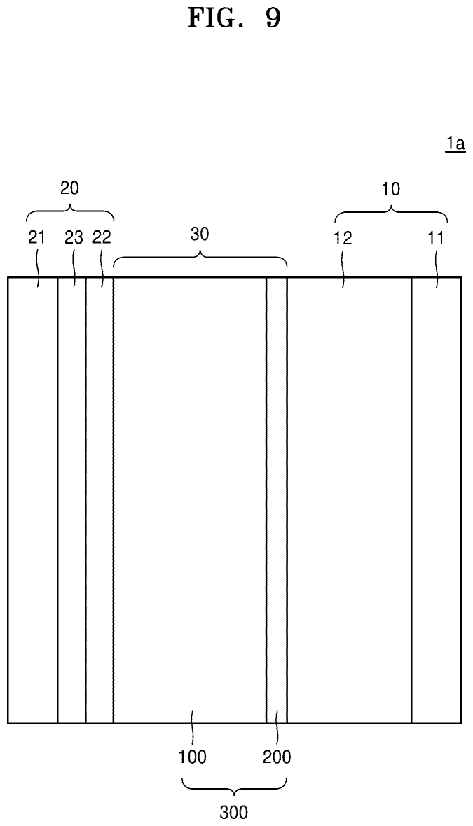

Alternatively, referring to FIGS. 8 and 9, the anode 20 may further include a second interlayer 22 disposed between the anode current collector 21 and the electrolyte layer 30.

The second interlayer 22 may include, for example, a carbon-containing material, a metal-based material, or a combination thereof; and a binder. The second interlayer 22 may not include an organic electrolyte solution.

The carbon-containing material and the metal-based material may be, for example, materials that may be lithiated and delithiated. The carbon-containing material and the metal-based material included in the interlayer have, for example, a particle form. An average particle diameter of the carbon-containing material and/or the metal-based material anode active material having the particle form may be, for example, about 10 nm to about 4 μm, about 10 nm to about 1 μm, about 10 nm to about 500 nm, about 10 nm to about 100 nm, or about 20 nm to about 80 nm. When the carbon-containing material and/or the metal-based material have an average particle diameter in such a range, reversible precipitation and/or dissolution of lithium may be more easily performed during charging or discharging. The average particle diameter of the carbon-containing material and/or the metal-based material may be, for example, a median diameter (D50) measured by using a laser type particle size distribution meter.

The second interlayer 22 may include, for example, at least one selected from the carbon-containing material and the metal-based material. The carbon-containing material may be, for example, amorphous carbon. Examples of the carbon-containing material include CB, AB, FB, KB, graphene, and the like, but one or more embodiments are not necessarily limited thereto. Any material may be used as long as the material may be classified as amorphous carbon in the art. The amorphous carbon may be carbon that has no crystallinity or very low crystallinity and may be distinguished from crystalline carbon or graphite-containing carbon. The metal-based material may be a metal material or a metalloid material. The metal-based material may include, for example, gold (Au), platinum (Pt), palladium (Pd), silicon (Si), silver (Ag), aluminum (Al), bismuth (Bi), tin (Sn), zinc (Zn), or a combination thereof. For example, nickel (Ni) may not form an alloy with lithium and thus may not be the metal-based material included in the interlayer in the present specification. The second interlayer 22 may include one material of the carbon-containing material and the metal-based material, or a mixture thereof. The second interlayer 22 may include, for example, amorphous carbon. The second interlayer 22 may include, for example, a mixture of amorphous carbon and gold (Au), platinum (Pt), palladium (Pd), silicon (Si), silver (Ag), aluminum (Al), bismuth (Bi), tin (Sn), zinc (Zn), or a combination thereof. A mixing ratio of the mixture may be, for example, a weight ratio of about 10:1 to about 1:2, about 10:1 to about 1:1, about 7:1 to about 1:1, about 5:1 to about 1:1, or about 4:1 to about 2:1. The second interlayer 22 may include, for example, a mixture of first particles including amorphous carbon and second particles including a metal or metalloid. Examples of the metal include gold (Au), platinum (Pt), palladium (Pd), silicon (Si), silver (Ag), aluminum (Al), bismuth (Bi), tin (Sn), zinc (Zn), or the like. A content of the second particles may be about 8 wt % to about 60 wt %, about 10 wt % to about 50 wt %, about 15 wt % to about 40 wt %, or about 20 wt % to about 30 wt % with respect to the total weight of the mixture. When the content of the second particles is in such a range, for example, the cycle characteristics of a lithium battery may be further improved.

The binder included in the second interlayer 22 may include, for example, SBR, PTFE, PVDF, polyethylene, a vinylidene fluoride/hexafluoropropylene copolymer, polyacrylonitrile, polymethyl methacrylate, or the like, but one or more embodiments are not necessarily limited thereto. Any material may be used as long as the material may be used as a binder in the art. The binder may be provided as a single binder or a plurality of different binders. The second interlayer 22 which does not include a binder may be easily separated from the electrolyte layer 30 or the anode active material layer 23. A content of the binder included in the interlayer 22 may be, for example, about 1 wt % to about 20 wt % with respect to the total weight of the second interlayer 22.

A thickness of the second interlayer 22 may be, for example, about 1 μm to about 20 μm, about 1 μm to about 15 μm, about 2 μm to about 10 μm, or about 3 μm to about 7 μm. The thickness of the second interlayer 22 may be, for example, of about 1% to about 50%, about 1% to about 30%, about 1% to about 10%, or about 1% to about 5% of a thickness of the cathode active material layer 12. When the second interlayer 22 is excessively thin, lithium dendrites formed between the second interlayer 22 and the anode current collector 21 may collapse the second interlayer 22, which may make it difficult to improve the cycle characteristics of the secondary battery 1 or 1a. When the thickness of the second interlayer 22 excessively increases, the energy density of the secondary battery 1 or 1a may decrease, and the cycle characteristics thereof may be difficult to improve. When the thickness of the second interlayer 22 decreases, for example, a charge capacity of the second interlayer 22 may also decrease. The charge capacity of the second interlayer 22 may be, for example, about 0.1% to about 50%, about 1% to about 30%, about 1% to about 10%, about 1% to about 5%, or about 1% to about 2% of a charge capacity of the cathode 10. When the charge capacity of the second interlayer 22 is excessively low, lithium dendrites formed between the second interlayer 22 and the anode current collector 21 may collapse the second interlayer 22, which may make it difficult to improve the cycle characteristics of the secondary battery 1 or 1a. When the charge capacity of the second interlayer 22 excessively increases, the energy density of the secondary battery 1 or 1a adopting the anode 20 may decrease, and the cycle characteristics thereof may be difficult to improve. A charge capacity of the cathode active material layer 12 may be obtained by multiplying a specific charge capacity (mAh/g) of a cathode active material by a mass of the cathode active material in the cathode active material layer 12. When various types of cathode active materials are used, a value of specific charge capacity x mass may be calculated for each cathode active material, and the sum of the values may be the charge capacity of the cathode active material layer 12. The charge capacity of the second interlayer 22 may also be calculated in the same manner. That is, the charge capacity of the second interlayer 22 may be obtained by multiplying a specific charge capacity (mAh/g) of a carbon-containing material and/or a metal-based material by a mass of the carbon-containing material and/or the metal-based material in the second interlayer 22. When various types of carbon-containing materials and/or metal-based materials are used, a value of specific charge capacity x mass may be calculated for each material, and the sum of the values may be a capacity of the second interlayer 22. Here, the specific charge capacities of the cathode active material and the carbon-containing material and/or metal-based material may be capacities estimated by using an all-solid-state half-cell using a lithium metal as a counter electrode. The charge capacities of the cathode active material layer 12 and the second interlayer 22 may be directly measured by measuring charge capacity by using the all-solid-state half-cell. When the measured charge capacity is divided by a mass of each active material, a specific charge capacity may be obtained. Alternatively, the charge capacities of the cathode active material layer 12 and the second interlayer 22 may be initial charge capacities measured during a 1^{st} cycle of charging.

### Anode: Introduction of Anode Active Material Layer

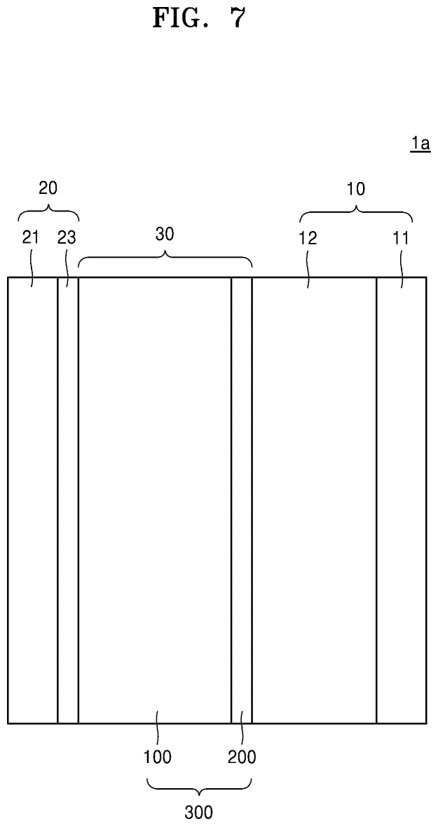

Referring to FIG. 6, after the assembly of the secondary battery 1 or 1a, the secondary battery 1 or 1a may include the cathode 10, the anode 20, and the electrolyte layer 30, and the anode 20 may include the anode current collector 21 and may not include the anode active material layer 23. The secondary battery 1 that does not include the anode active material layer 23 of FIG. 6 may be charged to obtain the secondary battery 1a of FIG. 7 which further includes the anode active material layer 23 disposed between the anode current collector 21 and the electrolyte layer 30. The anode active material layer 23 may be a lithium metal layer precipitated through charging.

Referring to FIGS. 6 and 7, in the secondary battery 1a including the anode active material layer 23 precipitated through charging, since the anode active material layer 23 is not included during the assembly of the secondary battery 1 or 1a, the energy density of the secondary battery 1 or 1a may increase.

For example, during charging of the secondary battery 1, lithium may be precipitated between the anode current collector 21 and the electrolyte layer 30, and the anode active material layer 23 may be formed by the precipitated lithium. The anode active material layer 23 may be a metal layer mainly including lithium (that is, metallic lithium). During discharging, lithium in the anode active material layer 23, that is, lithium in the metal layer, may be ionized to move toward the cathode 10. Lithium may be used as an anode active material in the secondary battery 1a. In the secondary battery 1a including the anode active material layer 23 precipitated through charging, a region between the anode current collector 21 and the electrolyte layer 30 may be a Li-free region that does not include a lithium (Li), for example, in an initial state of the secondary battery 1 or a state after discharging thereof.

Referring to FIG. 8, after the assembly of the secondary battery 1 or 1a, the secondary battery 1 or 1a may include the cathode 10, the anode 20, and the electrolyte layer 30, and the anode 20 may include the anode current collector 21 and the second interlayer 22 and may not include the anode active material layer 23. The second interlayer 22 may include, for example, a carbon-containing material and/or a metal-based material. The secondary battery 1 that does not include the anode active material layer 23 of FIG. 8 may be charged to obtain the secondary battery 1a of FIG. 9 which further includes the anode active material layer 23 disposed between the anode current collector 21 and the second interlayer 22. The anode active material layer 23 may be a lithium metal layer precipitated through charging.

For example, during charging of the secondary battery 1 or 1a, the second interlayer 22 may be charged beyond a charge capacity thereof. That is, the second interlayer 22 may be overcharged. At the beginning of charging, lithium may be adsorbed in the second interlayer 22. The carbon-containing material and/or metal-based material included in the second interlayer 22 may form an alloy or compound with lithium ions supplied from the cathode 10. When charging is performed beyond the capacity of the second interlayer 22, for example, lithium may be precipitated on a rear side of the second interlayer 22, for example, between the anode current collector 21 and the second interlayer 22, and the anode active material layer 23 may be formed by the precipitated lithium. The anode active material layer 23 may be a metal layer mainly including lithium (that is, metallic lithium). Such a result is obtained, for example, because the carbon-containing material and/or metal-based material included in the second interlayer 22 include a material that forms an alloy or compound with lithium. During discharge, lithium in the second interlayer 22 and the anode active material layer 23, that is, lithium in the metal layer, may be ionized to move toward the cathode 10. Lithium may be used as an anode active material in the secondary battery 1a. The second interlayer 22 may cover the anode active material layer 23, thereby serving as a protective layer for the anode active material layer 23, that is, the metal layer, and simultaneously serving to suppress the precipitation growth of lithium dendrites. The second interlayer 22 may suppress a short circuit and a capacity reduction of the secondary battery 1 or 1a and may improve the cycle characteristics of the secondary battery 1 or 1a. When the anode active material layer 23 is disposed by the secondary battery 1 or 1a being charged after being assembled, the anode current collector 21, the second interlayer 22, and a region therebetween may be Li-free regions that do not include lithium (Li), for example, in an initial state of the secondary battery 1 or 1a in a state after discharging thereof.

Alternatively, referring to FIGS. 7 and 9, for example, the anode active material layer 23 may be disposed between the anode current collector 21 and the electrolyte layer 30 or between the anode current collector 21 and the second interlayer 22 during the assembly of the secondary battery 1a. For example, during the assembly of the secondary battery 1, lithium foil may be disposed between the anode current collector 21 and the electrolyte layer 30 or between the anode current collector 21 and the second interlayer 22. When the anode active material layer 23 is disposed between the anode current collector 21 and the electrolyte layer 30 or between the anode current collector 21 and the second interlayer 22 during the assembly of the secondary battery 1, the anode active material layer 23 may be the metal layer including a lithium metal or lithium alloy, thereby serving as a lithium reservoir. The anode active material layer 23 may include, for example, a lithium metal, a lithium alloy, or a combination thereof.

Hereinafter, the definition of a substituent used in Formulas will be described.

As used in formulas, the term “alkyl” may refer to a fully saturated branched or unbranched (or straight-chain or linear) hydrocarbon.

Non-limiting examples of the “alkyl” include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, and n-heptyl.

At least one hydrogen atom of the “alkyl” may be substituted with a halogen atom, a C1-C30 alkyl group substituted with a halogen atom (for example, CCF₃, CHCF₂, CH₂F, or CCl₃), a C1-C30 alkoxy, a C2-C30 alkoxyalkyl, a hydroxyl group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid or a salt thereof, a C1-C30 alkyl group, a C2-C30 alkenyl group, a C2-C30 alkynyl group, a C1-C30 heteroalkyl group, a C6-C30 aryl group, a C7-C30 arylalkyl group, a C2-C30 heteroaryl group, a C2-C30 heteroarylalkyl group, a C2-C30 heteroaryloxy group, a C3-C30 heteroaryloxy alkyl group, or a C6-C30 heteroarylalkyloxy group.

The term “alkylene” used in formulas may refer to “alkyl” which is a diradical, and the alkyl may be as described above. A diradical may be for example, an alkyl group that requires two connection points. An alkylene group may include diradicals such as —CH₂—, —CH₂CH₂—, and —CH₂CH(CH₃)CH₂—.

Non-limiting examples of the “alkylene” include methylene, ethylene, n-propylene, isopropylene, n-butylene, isobutylene, sec-butylene, n-pentylene, isopentylene, neopentylene, n-hexylene, 3-methylhexylene, 2,2-dimethylpentylene, 2,3-dimethylpentylene, and n-heptylene.

The term “halogen atom” may include fluorine, bromine, chlorine, iodine, and the like.

The term “C1-C30 alkyl group substituted with a halogen atom” may refer to a C1-C30 alkyl group substituted with at least one halo group, and non-limiting examples thereof include monohaloalkyl, dihaloalkyl, or polyhaloalkyl which includes perhaloalkyl.

The monohaloalkyl may refer to an alkyl group that contains one iodine, one bromine, one chlorine, or one fluorine, and the dihaloalkyl and the polyhaloalkyl may each refer to an alkyl group having two or more identical or different halo atoms.

The term “alkoxy” used in formulas may refer to alkyl-O—, wherein the alkyl is as described above. Non-limiting examples of the alkoxy include methoxy, ethoxy, propoxy, 2-propoxy, butoxy, tert-butoxy, pentyloxy, hexyloxy, cyclopropoxy, and cyclohexyloxy. At least one hydrogen atom in the alkoxy group may be substituted with the same substituent as in the case of the alkyl group described above.

As used in formulas, the term “aryl” group may be used alone or in combination and may refer to an aromatic hydrocarbon containing one or more rings.

The term “aryl” may also include a group in which an aromatic ring is fused to at least one cycloalkyl ring.

Non-limiting examples of the “aryl” include phenyl, naphthyl, and tetrahydronaphthyl.

In addition, at least one hydrogen atom in the “aryl” may be substituted with the same substituent as in the case of the alkyl group described above.

The term “heteroaryl” used in formulas may refer to a monocyclic or bicyclic organic compound which has at least one hetero atom selected from N, O, P, or S and in which the remaining ring atoms are carbon. The heteroaryl group may include, for example, 1-5 heteroatoms and 5-10 ring members. The heteroaryl group may include, for example, 1 to 5 heteroatoms, and 5 to 10 ring members.

S or N may be oxidized to have various oxidation states.

Examples of a monocyclic heteroaryl group include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl group, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazine-2-yl, pyrazin-4-yl, pyrazin-5-yl, 2-pyrimidin-2-yl, 4-pyrimidin-2-yl, or 5-pyrimidin-2-yl.

The term “heteroaryl” may include a group in which a heteroaromatic ring is fused to at least one aryl, cycloaliphatic, or heterocyclic group.

At least one hydrogen atom of the “heteroaryl” may be substituted with the same substituent as in the case of the alkyl group described above.

Hereinafter, the disclosure will be described in detail through the following Examples and Comparative Examples. However, the scope of the disclosure is not limited thereto.

### Preparation of Catholyte

### Preparation Example 1 (LiFSI+EMIFSI+F5CN)

A catholyte was prepared by adding 1.0 M LiFSI as a lithium salt to a mixed solution of 1-ethyl-3-methylimidazolium bis(fluorosulfonyl)imide (EMIFSI) as an ionic liquid and 3-(2,2,3,3,3-pentafluoropropoxy)propanenitrile (manufactured by Chunbo Co., Ltd.) as a fluorinated solvent mixed at a volume ratio of 1:2.

### Preparation Example 2 (LiFSI+F5CN)

A catholyte was prepared by adding 2.0 M LiFSI as a lithium salt to 3-(2,2,3,3,3-pentafluoropropoxy)-(2,2,3,3,3-pentafluoropropoxy)propanenitrile (manufactured by Chunbo Co., Ltd.) as a fluorinated solvent.

### Preparation Example 3 (LiFSI+EMIFSI+F4CN)

A catholyte was prepared by adding 20 M LiFSI as a lithium salt to a mixed solution of EMIFSI as an ionic liquid and 3-(2,2,3,3-tetrafluoropropoxy)propanenitrile (manufactured by Chunbo Co., Ltd.) as a fluorinated solvent mixed at a volume ratio of 1:2.

### Preparation Example 4 (LiFSI+F4CN)

A catholyte was prepared by adding 2.0 M LiFSI as a lithium salt to 3-(2,2,3,3,3-pentafluoropropoxy)-(2,2,3,3,3-pentafluoropropoxy)propanenitrile (manufactured by Chunbo Co., Ltd.) as a fluorinated solvent.

### Comparative Preparation Example 1 (LiFSI+EMIFSI)

A catholyte was prepared by adding 2.0 M LiFSI as a lithium salt to EMIFSI as an ionic liquid.

### Comparative Preparation Example 2 (LiFSI+BIB10FSI)

A catholyte was prepared by adding 2.0 M LiFSI as a lithium salt to 1,3,5-trimethyl-1H-imidazol-3-ium bis(fluorosulfonyl)imide (manufactured by Chunbo Co., Ltd.) as an ionic liquid.

### Example 1

### Preparation of Cathode

LiCoO₂ (LCO) was prepared as a cathode active material. CB (manufactured by Cabot Corporation) and graphite (SFG6 manufactured by Timcal Ltd) were prepared as conductive materials. PTFE was prepared as a binder. A cathode active material, CB, graphite, and a binder were mixed at a mass ratio of 93:3:1:3 to prepare a mixture. The mixture was stretched into a sheet form to prepare a cathode active material layer sheet. A cathode was prepared by pressing the cathode active material layer sheet onto a cathode current collector made of aluminum foil with a thickness of 12 μm.

A catholyte prepared in Preparation Example 1 was injected into a cathode active material layer to impregnate the cathode active material layer with the catholyte.

### Preparation of Solid Electrolyte Layer/Interlayer/Anode Stack

Pellets of Li_{6.5}La₃Zr_{1.5}Ta_{0.5}O₁₂ (LLZO manufactured by Toshima manufacturing Corp., Japan) were prepared as a solid electrolyte layer.

Carbon-containing material (CB) and an NMP solution including 7 wt % of a PVDF binder (#9300 manufactured by Kureha Corporation) were mixed at a weight ratio of 1:1 to prepare a mixed solution. While NMP was added little by little to the prepared mixed solution, the mixed solution was stirred to prepare a slurry. The prepared slurry was applied onto SUS304 foil with a thickness of 10 μm by using a bar coater, dried in air at a temperature of 80° C. for 10 minutes, and then vacuum-dried at a temperature of 40° C. for 10 hours to prepare a first stack. A second stack was prepared by arranging the first stack on the solid electrolyte layer such that a carbon-containing material layer of the first stack faced the solid electrolyte layer. The second stack was pressed at a pressure of 250 MPa at a temperature 25° C. for 3 minutes through cold isotactic pressing (CIP). The SUS304 foil was removed from the pressed second stack to prepare a third stack including a solid electrolyte/interlayer (carbon-containing material layer).

A copper/lithium stack was prepared in which 20 μm thick metallic lithium was deposited on 10 μm thick copper foil. A fourth stack was prepared by arranging the copper/lithium stack on the interlayer of the third stack such that the metallic lithium faced the interlayer. The fourth stack was pressed at a pressure of 250 MPa at a temperature of 25° C. for 3 minutes through IP to prepare a solid electrolyte layer/interlayer (carbon-containing material layer)/anode stack.

### Manufacturing of Hybrid Secondary Battery

The cathode was disposed on the solid electrolyte layer of the solid electrolyte layer/interlayer/anode stack such that the cathode active material layer faced the solid electrolyte layer, and a 2032 coin cell assembly was used, thereby manufacturing a hybrid secondary battery of a coin cell type.

### Preparation of Composite Solid Electrolyte

The manufactured hybrid secondary battery was charged or discharged at a temperature of 25° C. under the following conditions.

In a 1^{st} cycle, the hybrid secondary battery was charged at a constant rate current rate of 0.3 mA/cm² until a battery voltage reached 4.5 V, and then the hybrid secondary battery was charged at a constant voltage until a current amount was reduced to 1/10. Next, discharging was performed at a constant current of 0.3 mA/cm² until the battery voltage reached 2.8 V.

The hybrid secondary battery charged/discharged in the 1^{st} cycle was disassembled, and XPS analysis was performed on a surface of the solid electrolyte layer in contact with the catholyte to confirm the presence of a second region including LiF, which covered a first region including an oxide solid electrolyte. More specific details of the composite solid electrolyte are as defined in Evaluation Example 1 and Evaluation Example 2.

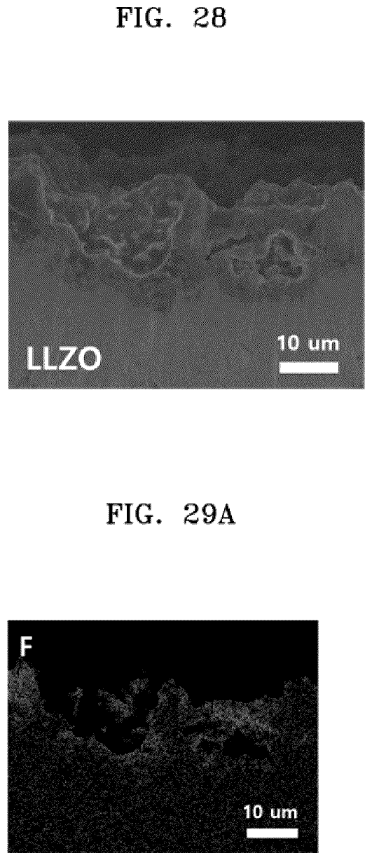

A SEM image of a cross section of the composite solid electrolyte is shown in FIG. 28.

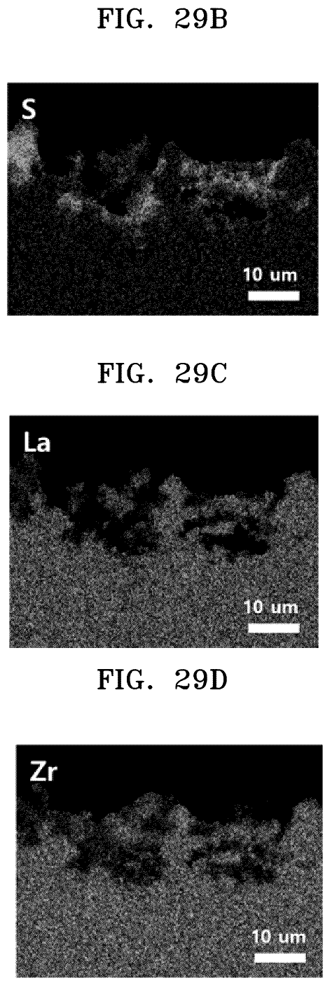

Energy-dispersive X-ray spectroscopy (EDX) mapping images of fluorine, sulfur, lanthanum, and zirconium on the cross section of the composite solid electrolyte are shown in FIGS. 29A to 29D, respectively.

As shown in FIGS. 28 and 29A to 29D, it was confirmed that the second region including fluorine and sulfur was disposed in the form of a conformal coating layer on a surface of the first region including an oxide solid electrolyte (LLZO).

### Examples 2 to 4

Hybrid secondary batteries and composite solid electrolytes were manufactured in the same manner as in Example 1, except that the catholytes prepared in Preparation Examples 2 to 4 were used, respectively.

### Comparative Examples 1 and Comparative Example 2

Hybrid secondary batteries and composite solid electrolytes were manufactured in the same manner as in Example 1, except that the catholytes prepared in Comparative Preparation Example 1 and Comparative Preparation Example 2 were used, respectively.

### Evaluation Example 1: XPS Depth Profile Analysis

In Examples 1 to 4, in Comparative Example 1, and Comparative Example 2, XPS depth profile analyses were performed on a surface of each of the composite solid electrolytes formed through a 1^{st} cycle, and sputtering was performed on the surface of the composite solid electrolyte to analyze a surface composition according to a depth. Representative analysis results are shown in FIGS. 10 to 13.

FIG. 10 shows results of XPS depth profile analysis of the surface of the composite solid electrolyte prepared in Example 1 according to a sputter time.

At a sputter time of 0 minutes, at a surface side of the composite solid electrolyte, the second region had a content of LiF of less than 1 at %, a content of N of about 11 at %, and a content of S of about 10 at % based on a total 100 at % of the second region.

After a sputter time of 1 minute, at a depth of about 5 nm from the surface of the composite solid electrolyte, the second region had a content of LiF of about 12 at %, a content of N of about 12 at %, and a content of S of about 10 at % based on a total 100 at % of the second region.

After a sputter time of 5 minutes, at a depth of about 25 nm from the surface of the composite solid electrolyte, the second region had a content of LiF of about 30 at %, a content of N of about 7 at %, and a content of S of about 5 at % based on a total 100 at % of the second region.

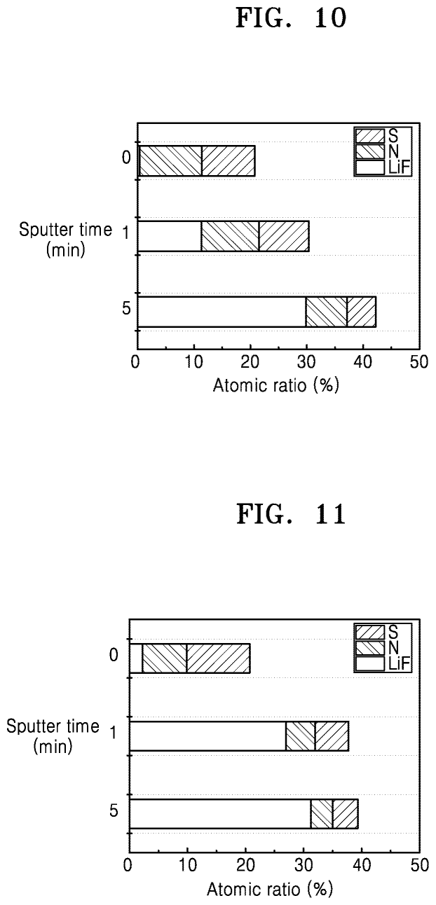

FIG. 11 shows results of XPS depth profile analysis of the surface of the composite solid electrolyte prepared in Example 2 according to a sputter time.

At a sputter time of 0 minutes, at a surface side of the composite solid electrolyte, the second region had a content of LiF of about 2 at %, a content of N of about 8 at %, and a content of S of about 11 at % based on a total 100 at % of the second region.

After a sputter time of 1 minute, at a depth of about 5 nm from the surface of the composite solid electrolyte, the second region had a content of LiF of about 27 at %, a content of N of about 5 at %, and a content of S of about 6 at % based on a total 100 at % of the second region.

After a sputter time of 5 minutes, at a depth of about 25 nm from the surface of the composite solid electrolyte, the second region had a content of LiF of about 31 at %, a content of N of about 4 at %, and a content of S of about 5 at % based on a total 100 at % of the second region.

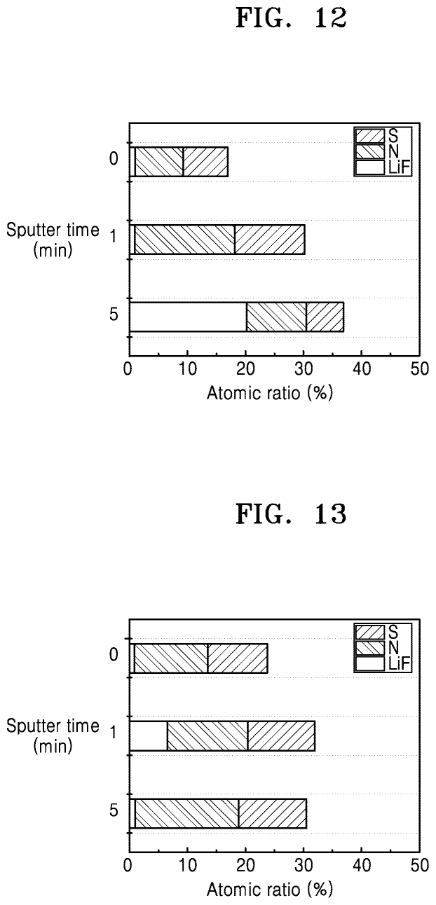

FIG. 12 shows results of XPS depth profile analysis of the surface of the composite solid electrolyte prepared in Comparative Example 1 according to a sputter time.

At a sputter time of 0 minutes, at a surface side of the composite solid electrolyte, the second region had a content of LiF of less than 1 at %, a content of N of about 9 at %, and a content of S of about 7 at % based on a total 100 at % of the second region.

After a sputter time of 1 minute, at a depth of about 5 nm from the surface of the composite solid electrolyte, the second region had a content of LiF of about 1 at %, a content of N of about 17 at %, and a content of S of about 12 at % based on a total 100 at % of the second region.

After a sputter time of 5 minutes, at a depth of about 25 nm from the surface of the composite solid electrolyte, the second region had a content of LiF of about 20 at %, a content of N of about 10 at %, and a content of S of about 7 at % based on a total 100 at % of the second region.

FIG. 13 shows results of XPS depth profile analysis of the surface of the composite solid electrolyte prepared in Comparative Example 2 according to sputter time.

At a sputter time of 0 minutes, at a surface side of the composite solid electrolyte, the second region had a content of LiF of less than 1 at %, a content of N of about 9 at %, and a content of S about 7 at % based on a total 100 at % of the second region.

After a sputter time of 1 minute, at a depth of about 5 nm from the surface of the composite solid electrolyte, the second region had a content of LiF of about 7 at %, a content of N of about 14 at %, and a content of S of about 11 at % based on a total 100 at % of the second region.

After a sputter time of 5 minutes, at a depth of about 25 nm from the surface of the composite solid electrolyte, the second region had a content of LiF of about 1 at %, a content of N of about 18 at %, and a content of S of about 12 at % based on a total 100 at % of the second region.

In FIGS. 10 to 13, components other than LiF, N, and S in the second region were, for example, components derived from an ionic liquid, a decomposition product of the ionic liquid, a lithium salt, a decomposition product of the lithium salt, or a combination thereof.

As shown in FIGS. 10 and 11, the content of LiF increased as the depth increased from the surface of the second region to the inside of the second region. That is, the content of LiF at the surface side of the composite solid electrolyte in the second region was lower than the content of LiF at a first region side including an oxide solid electrolyte, that is, the content of LiF at an interface side between the first region and the second region.

As shown in FIGS. 10 and 11, the second region of Example 1 and Example 2 included a 2-2 region in which a content of LiF was 10 at % or less based on a total 100 at % of the 2-2 region at a sputter time of 0 minutes.

As shown in FIGS. 10 and 11, the second region of Example 1 and Example 2 included a 2-1 region in which a content of LiF was 25 at % or more based on a total 100 at % of the 2-1 region after a sputter time of 5 minutes.

On the other hand, as shown in FIGS. 12 and 13, the content of LiF of the second region in Comparative Example 1 and Comparative Example 2 was less than 20 at % based on a total 100 at % of the second region.

As shown in FIGS. 10 and 11, the content of LiF of the second region of Example 1 and Example 2 exceeded 30% of the total content of LiF, N, and S after a sputter time of 1 minute.

On the other hand, as shown in FIGS. 12 and 13, in the second region of Comparative Example 1 and Comparative Example 2, the content of LiF was less than 30% of the total content of LiF, N, and S after a sputter time of 1 minute.

### Evaluation Example 2: XPS Depth Profile Analysis According to Position

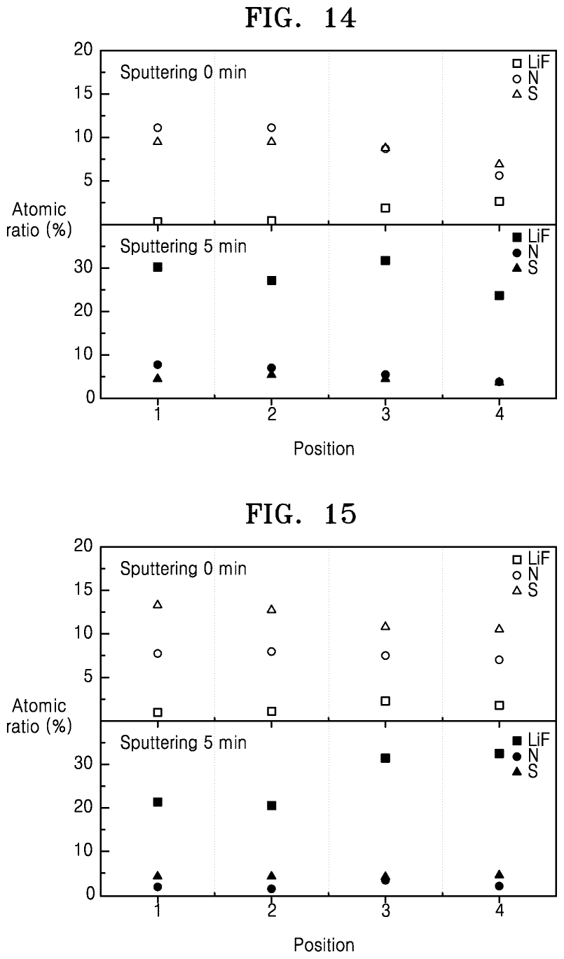

In Examples 1 to 4, in Comparative Example 1, and Comparative Example 2, XPS depth profile analyses were performed on four points of the surface of each of the composite solid electrolytes formed through a 1^{st} cycle, and sputtering was performed on the surface of each of the composite solid electrolytes to analyze a surface composition according to a depth. Representative analysis results are shown in FIGS. 14 to 17. Each of the four points was regarded to indicate an area corresponding to 25% of the total area of the surface of the composite solid electrolyte.

FIGS. 14 and 15 provide the results of XPS depth profile analysis for a first point (position 1), a second point (position 2), a third point (position 3), and a fourth point (position) on the surfaces of the composite solid electrolytes prepared in Example 1 and Example 2 at sputter times (0 minutes and 5 minutes), respectively.

As shown in FIG. 14, in the second region of the composite solid electrolyte of Example 1, after sputtering for 5 minutes, a content of LiF of was about 23 at % or more at the first point, the second point, and the third point based on a total 100 at % of the second region.

As shown in FIG. 15, in the second region of the composite solid electrolyte of Example 2, after sputtering for 5 minutes, a content of LiF was about 23 at % or more at the third and fourth points, and a content of LiF was about 20 at % at the first point and second point based on a total 100 at % of the second region.

Accordingly, in the composite solid electrolytes of Examples 1 and 2, an area of a 2-1 region including LiF in a content of 23 at % or greater was 50% or greater of the total area of the second region. In addition, in the composite solid electrolytes of Example 1 and Example 2, it was determined that the second region was disposed in a conformal form entirely on a surface of the first region.

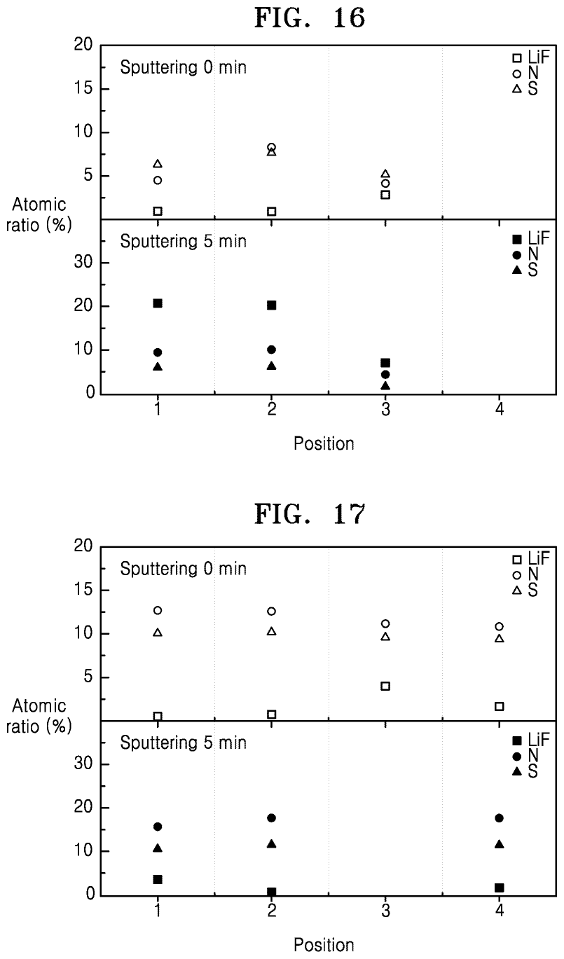

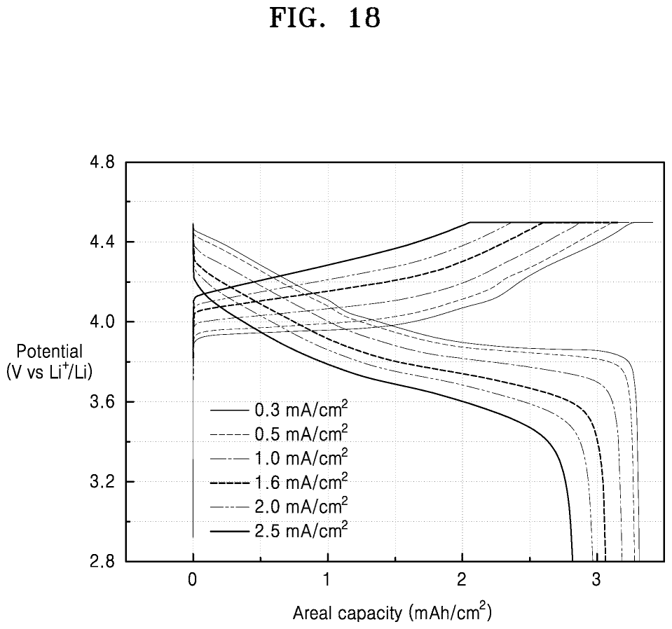

FIGS. 16 and 17 provide the results of XPS depth profile analyses of a first point (position 1), a second point (position 2), a third point (position 3), and a fourth point (position) on the surfaces of the composite solid electrolytes prepared in Comparative Example 1 and Comparative Example 2 at sputter times (0 minutes and 5 minutes), respectively.

As shown in FIG. 16, in the second region of the composite solid electrolyte of Comparative Example 1, after sputtering for 5 minutes, a content of LiF was less than about 23 at % at all points, and LiF was not detected at the fourth point based on a total 100 at % of the second region.

As shown in FIG. 17, in the second region of the composite solid electrolyte of Comparative Example 2, after sputtering for 5 minutes, a content of LiF was less than about 5 at % at all points, and LiF was not detected at the third point based on a total 100 at % of the second region.

Accordingly, the second region of the composite solid electrolyte of Comparative Example 1 and Comparative Example 2 did not have a 2-1 region including LiF in a content of 23 at % or greater based on a total 100 at % of the 2-1 region. In addition, in the composite solid electrolytes of Comparative Example 1 and Comparative Example 2, it was determined that the second region was partially arranged in an island shape on a surface of the first region.

### Evaluation Example 3: Low Rate Charge/Discharge Test

The charge/discharge characteristics of the hybrid secondary batteries manufactured in Examples 1 to 4, Comparative Example 1, and Comparative Example 2 were evaluated with the following charge/discharge test conditions. The charge/discharge test was performed at a temperature of 25° C.

In a 1^{st} cycle, the hybrid secondary batteries were charged at a constant current of 0.3 mA/cm² until a battery voltage reached 4.5 V, and then the hybrid secondary batteries were charged at a constant voltage until a current amount was reduced to 1/10. Next, discharging was performed at a constant current of 0.3 mA/cm² until the battery voltage reached 2.8 V.

As shown in Evaluation Example 1 and Evaluation Example 2, a composite solid electrolyte was formed through the 1^{st} cycle.

In a 2^{nd} cycle, the hybrid secondary batteries were charged at a constant current of 0.5 mA/cm² until a battery voltage reached 4.5 V, and then the hybrid secondary batteries were charged at a constant voltage until a current amount was reduced to 1/10. Next, discharging was performed at a constant current of 0.3 mA/cm² until the battery voltage reached 2.8 V.

In a 3^{rd} cycle, the hybrid secondary batteries were charged at a constant current of 1.0 mA/cm² until a battery voltage reached 4.5 V, and then the hybrid secondary batteries were charged at a constant voltage until a current amount was reduced to 1/10. Next, discharging was performed at a constant current of 1.0 mA/cm² until the battery voltage reached 2.8 V.

In a 4^{th} cycle, the hybrid secondary batteries were charged at a constant current of 1.6 mA/cm² until a battery voltage reached 4.5 V, and then the hybrid secondary batteries were charged at a constant voltage until a current amount was reduced to 1/10. Next, discharging was performed at a constant current of 1.6 mA/cm² until the battery voltage reached 2.8 V.

In a 5th cycle, the hybrid secondary batteries were charged at a constant current of 2.0 mA/cm² until a battery voltage reached 4.5 V, and then the hybrid secondary batteries were charged at a constant voltage until a current amount was reduced to 1/10. Next, discharging was performed at a constant current of 2.0 mA/cm² until the battery voltage reached 2.8 V.

In a 6th cycle, the hybrid secondary batteries were charged at a constant current of 2.5 mA/cm² until a battery voltage reached 4.5 V, and then the hybrid secondary batteries were charged at a constant voltage until a current amount was reduced to 1/10. Next, discharging was performed at a constant current of 2.5 mA/cm² until the battery voltage reached 2.8 V.

The hybrid secondary batteries were rested for 10 minutes after every charging/discharging cycle.

### Evaluation Example 4: High Rate Charge/Discharge Test

The charge/discharge characteristics of the hybrid secondary batteries manufactured in Examples 1 to 4, Comparative Example 1, and Comparative Example 2 were evaluated through the following charge/discharge test. The charge/discharge test was performed at a temperature of 25° C.

In a 1^{st} cycle, the hybrid secondary batteries were charged at a constant current of 2.5 mA/cm² until a battery voltage reached 4.5 V, and then the hybrid secondary batteries were charged at a constant voltage until a current amount was reduced to 1/10. Next, discharging was performed at a constant current of 2.5 mA/cm² until the battery voltage reached 2.8 V.

As shown in Evaluation Example 1 and Evaluation Example 2, a composite solid electrolyte was formed through the 1^{st} cycle.

In a 2^{nd} cycle, the hybrid secondary batteries were charged at a constant current of 3.0 mA/cm² until a battery voltage reached 4.5 V, and then the hybrid secondary batteries were charged at a constant voltage until a current amount was reduced to 1/10. Next, discharging was performed at a constant current of 3.0 mA/cm² until the battery voltage reached 2.8 V.

In a 3^{rd} cycle, the hybrid secondary batteries were charged at a constant current of 3.5 mA/cm² until a battery voltage reached 4.5 V, and then the hybrid secondary batteries were charged at a constant voltage until a current amount was reduced to 1/10. Next, discharging was performed at a constant current of 3.5 mA/cm² until the battery voltage reached 2.8 V.

In a 4^{th} cycle, the hybrid secondary batteries were charged at a constant current of 4.0 mA/cm² until a battery voltage reached 4.5 V, and then the hybrid secondary batteries were charged at a constant voltage until a current amount was reduced to 1/10. Next, discharging was performed at a constant current of 4.0 mA/cm² until the battery voltage reached 2.8 V.

The hybrid secondary batteries were rested for 10 minutes after every charging/discharging cycle.

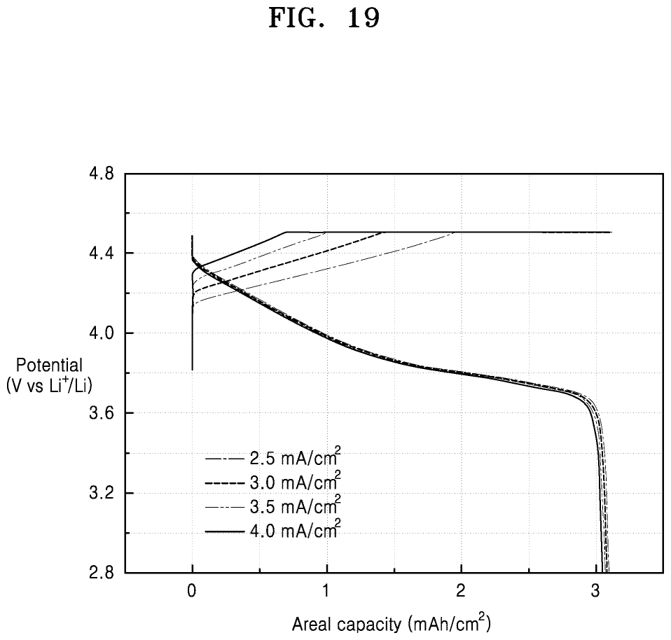

Based on results of Evaluation Example 3 and Evaluation Example 4 above, results of charging/discharging the hybrid secondary battery of Example 1 are shown in FIGS. 18 and 19, respectively. As shown in FIG. 18, a decrease in discharge capacity was less than 20% as a current amount was increased. As shown in FIG. 19, it was confirmed that a change in discharge capacity was insignificant at a high current rate of 2.5 mA/cm² or greater, and thus the high rate characteristics were excellent.

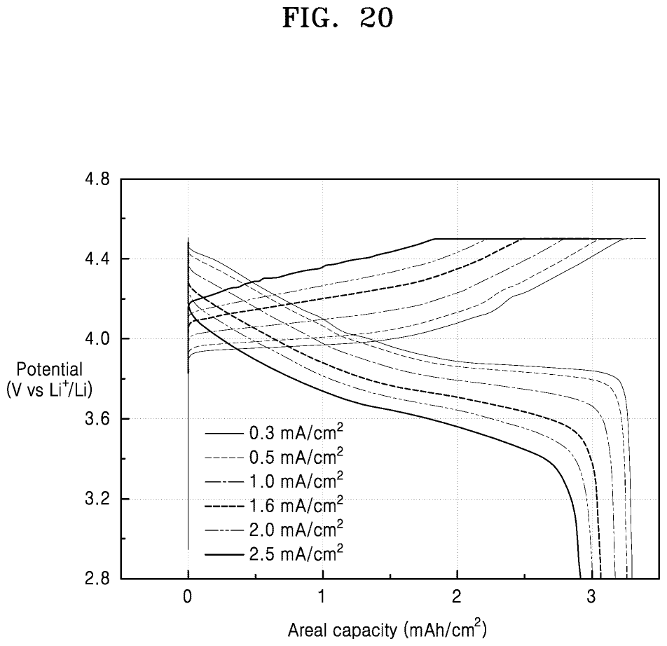

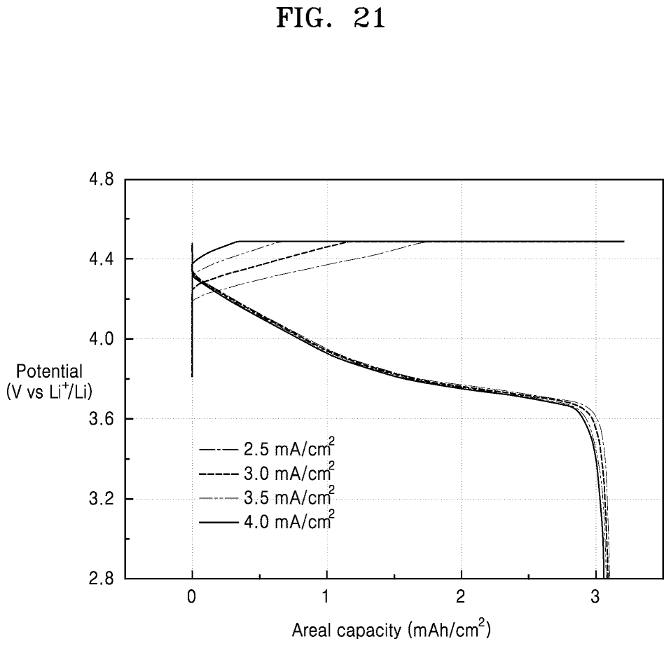

Results of charging/discharging results the hybrid secondary battery of Example 2 are shown in FIGS. 20 and 21, respectively. As shown in FIG. 20, a decrease in discharge capacity was less than 20% as a current amount was increased. As shown in FIG. 21, it was confirmed that a change in discharge capacity was insignificant at a high current rate of 2.5 mA/cm² or more, and thus the high rate characteristics were excellent.

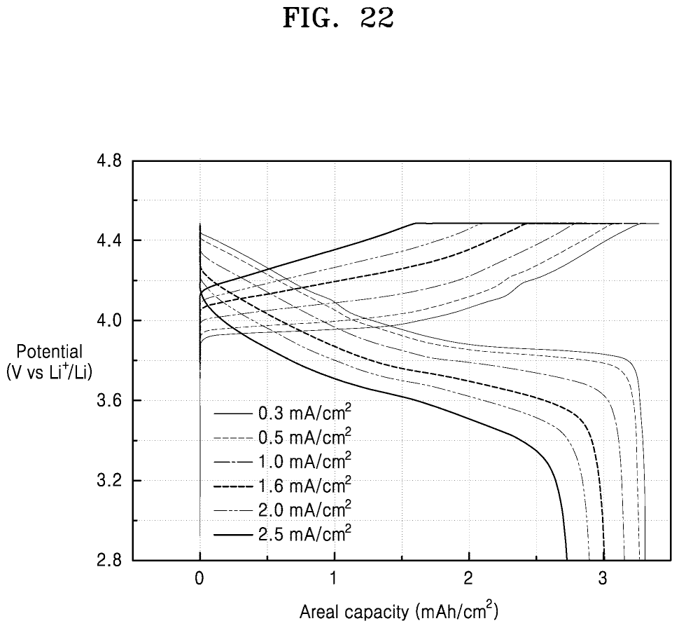

Results of charging/discharging results the hybrid secondary battery of Example 3 are shown in FIG. 22. As shown in FIG. 22, a decrease in discharge capacity was less than 20% as a current amount was increased.

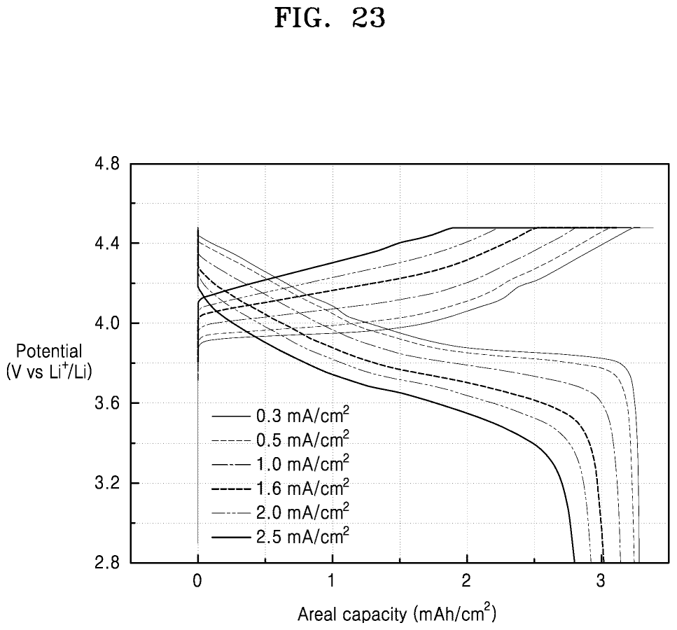

Results of charging/discharging results the hybrid secondary battery of Example 4 are shown in FIG. 23. As shown in FIG. 23, a decrease in discharge capacity was less than 20% as a current amount was increased.

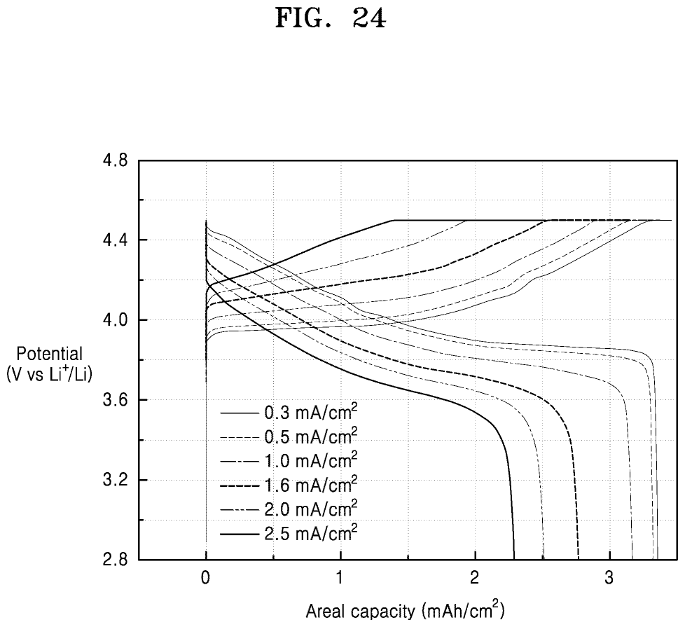

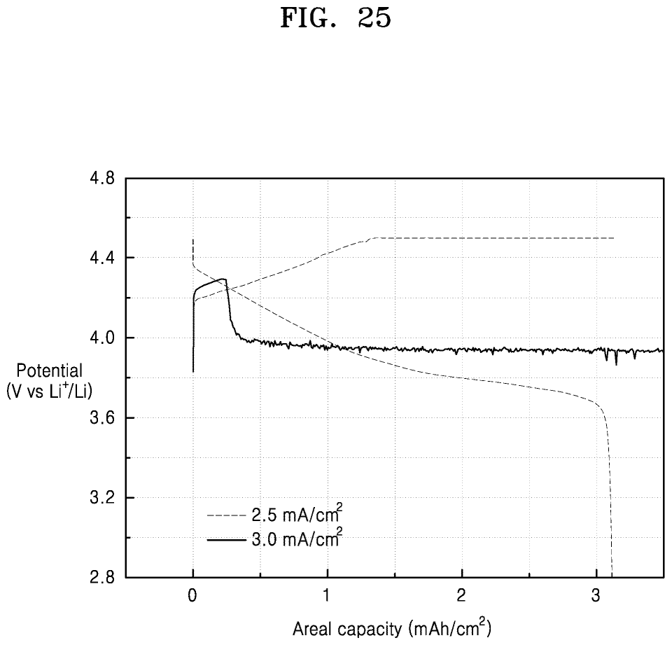

Results of charging/discharging results the hybrid secondary battery of Comparative Example 1 are shown in FIGS. 24 and 25, respectively. As shown in FIG. 24, a decrease in discharge capacity was 25% or more as a current amount was increased. As shown in FIG. 25, a short circuit occurred at a high current of 3.0 mA/cm² or greater.

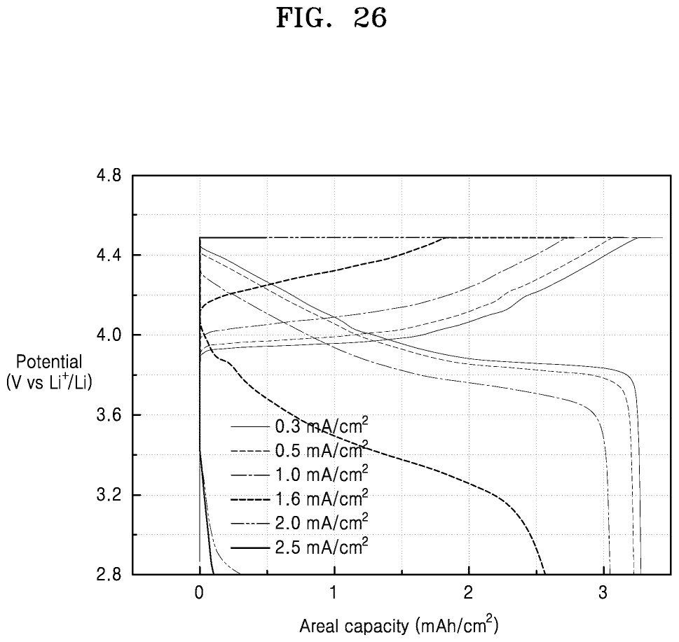

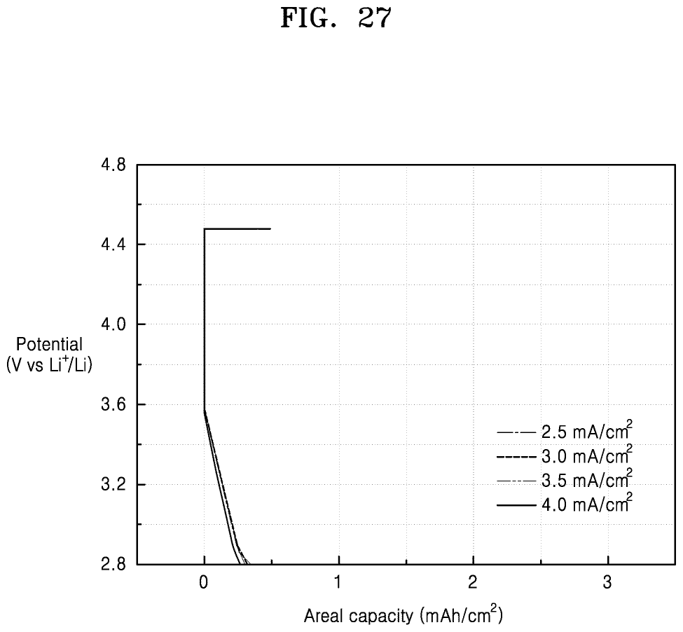

Results of charging/discharging results the hybrid secondary battery of Comparative Example 2 are shown in FIGS. 26 and 27, respectively. As shown in FIG. 26, a decrease in discharge capacity was 80% or more as a current amount was increased. As shown in FIG. 27, discharge capacity was insignificant at a high current of 2.5 mA/cm² or greater.

Referring to FIGS. 18 to 23, since the hybrid secondary batteries of Examples 1 to 4 included the composite solid electrolyte including the 2-1 region, side reactions during charging or discharging were suppressed. Accordingly, the high rate characteristics and high output characteristics of the hybrid secondary batteries of Examples 1 to 4 were improved.

Referring to FIGS. 24 to 27, since the hybrid secondary batteries of Comparative Example 1 and Comparative Example 2 did not include the composite solid electrolyte including the 2-1 region, side reactions during charging or discharging were increased. Accordingly, the high rate characteristics and high output characteristics of the hybrid secondary batteries of Comparative Example 1 and Comparative Example 2 deteriorated.

While embodiments have been described in detail with reference to the accompanying drawings, the present inventive concept is not limited to the embodiments. It is obvious to those skilled in the art to which the present inventive concept belongs that various changes and modifications are conceivable within the scope of the technical idea described in the claims, and those are understood as naturally belonging to the technical scope of the present inventive concept.

According to an aspect, a composite solid electrolyte may suppress an increase in internal resistance of a secondary battery and may suppress side reactions during charging or discharging, thereby providing a secondary battery having improved high rate characteristics and high output characteristics.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

1. A composite solid electrolyte comprising:
a first region; and
a second region covering at least a portion of the first region,
wherein
the first region comprises an oxide solid electrolyte,
the second region comprises LiF,
in the second region, a content of the LiF at a surface side of the composite solid electrolyte is less than a content of the LiF at an interface side between the first region and the second region, and
when a depth profile of the composite solid electrolyte is analyzed by X-ray photoelectron spectroscopy, the second region comprises a 2-1 region having a content of the LiF of about 23 atomic percent to about 40 atomic percent based on a total 100 atomic percent of the 2-1 region.

2. The composite solid electrolyte of claim 1, wherein, when a depth profile of the composite solid electrolyte is analyzed by X-ray photoelectron spectroscopy, the second region comprises a 2-2 region having a content of the LiF of 10 atomic percent or less based on a total 100 atomic percent of the 2-2 region,
wherein the 2-2 region is disposed closer to a surface of the composite solid electrolyte than the 2-1 region.

3. The composite solid electrolyte of claim 1, wherein an area of the 2-1 region is 25% or more of a total area of the second region.

4. The composite solid electrolyte of claim 1, wherein the second region further comprises at least one non-metallic element selected from Groups 15 to 17 of the periodic table of elements,
wherein the non-metallic element comprises N, S, F, C, O, H, or a combination thereof.

5. The composite solid electrolyte of claim 1, wherein, in the second region, a content of a non-metallic element at the surface side of the composite solid electrolyte is greater than a content of the non-metallic element at the interface side between the first region and the second region,
the second region has a concentration gradient in which a concentration of the non-metallic element decreases in a direction from a surface of the composite solid electrolyte to an interface between the first region and the second region, and
in the second region, a content of each of S and N at the surface side of the composite solid electrolyte is less than a content of each of S and N at the interface side between the first region and the second region.

6. The composite solid electrolyte of claim 1, wherein the second region further comprises Li₂S, Li₃N, LiNO₃, Li₂SO₄, LiOH, or a combination thereof.

7. The composite solid electrolyte of claim 1, wherein, when a depth profile of the composite solid electrolyte is analyzed by X-ray photoelectron spectroscopy, at a depth of 5 nanometers or greater from a surface of the composite solid electrolyte, a ratio of a content of the LiF content to a total content of LiF, S, and N is greater than 0.30.

8. The composite solid electrolyte of claim 1, wherein the second region has a thickness of 100 nanometers or less.

9. The composite solid electrolyte of claim 1, wherein the second region is a conformal coating layer disposed on the first region along a surface contour of the first region.

10. The composite solid electrolyte of claim 1, wherein the second region is a coating layer having a multi-layer structure and comprises: a first coating layer comprising the 2-1 region; and a second coating layer disposed on the first coating layer and comprising a 2-2 region.

11. The composite solid electrolyte of claim 10, wherein the 2-1 region comprises an inorganic layer comprising LiF, S, and N, and
the 2-2 region comprises an inorganic layer, an organic-inorganic composite layer, or a combination thereof.

12. The composite solid electrolyte of claim 11, wherein the 2-2 region comprises an ionic liquid, a decomposition product of the ionic liquid, a fluorinated organic solvent, a decomposition product of the fluorinated organic solvent, a lithium salt, a decomposition product of the lithium salt, or a combination thereof.

13. The composite solid electrolyte of claim 1, wherein the oxide solid electrolyte comprises: lithium phosphorus oxynitride, Li₃ₓLa_{(2/3x)(3-2x)}TiO₃, wherein 0.04<x<0.16; Li₁₊ₓAlₓTi₂₋ₓ(PO₄)₃, wherein 0<x<2; Li₁₊ₓAlₓGe₂₋ₓ(PO₄)₃, wherein 0<x<2; Li_{1+x+y}AlₓTi₂₋ₓSi_{y}P_{3-y}O₁₂, wherein 0≤x<2 and 0≤y<³; BaTiO₃; Pb(ZrₐTi₁₋ₐ)O₃, wherein 0≤a≤1; Pb₁₋ₓLaₓZr_{1-y}Ti_{y}O₃; wherein 0≤x<1 and 0≤y<1; Pb(Mg_{1/3}Nb_{2/3})O₃—PbTiO₃; HfO₂; SrTiO₃; SnO₂; CeO₂; Na₂O; MgO; NiO; CaO; BaO; ZnO; ZrO₂; Y₂O₃; Al₂O₃; TiO₂; SiO₂; Li₃PO₄; LiₓTi_{y}(PO₄)₃, wherein 0<x<2 and 0<y<3; LiₓAl_{y}Ti_{z}(PO₄)₃, wherein 0<x<2, 0<y<1, and 0<z<3; Li_{1+x+y}(AlₐGa₁₋ₐ)ₓ(Ti_{b}Ge_{1-b})₂₋ₓSi_{y}P_{3-y}O₁₂, wherein 0≤x≤1, 0≤y≤1, 0≤a≤1, and 0≤b≤1; LiₓLa_{y}TiO₃, wherein 0<x<2 and 0<y<3; Li₂O, LiOH; Li₂CO₃; LiAlO₂; Li₂O—Al₂O₃—SiO₂—P₂O₅—TiO₂—GeO₂; Li₃₊ₓLa₃M₂O₁₂, wherein M is Te, Nb, or Zr, and 1≤x≤10; Li₇La₃Zr₂O₁₂; Li₃₊ₓLa₃Zr₂₋ₐMₐO₁₂, wherein M is Ga, W, Nb, Ta, or Al, 0<a<2, and 1≤x≤10; or a combination thereof,
the oxide solid electrolyte is crystalline, amorphous, glassy, or glass-ceramic, and
the first region has a thickness of 100 micrometers or less.

14. A secondary battery comprising:
a cathode;
an anode; and
an electrolyte layer disposed between the cathode and the anode,
wherein the electrolyte layer comprises the composite solid electrolyte of claim 1, and
the second region of the composite solid electrolyte is adjacent to the cathode.

15. The secondary battery of claim 14, wherein the secondary battery is an all-solid secondary battery, a semi-solid secondary battery, or a hybrid secondary battery.

16. The secondary battery of claim 14, wherein the cathode comprises a catholyte,
wherein the catholyte comprises a lithium salt, a fluorinated solvent, or a combination thereof.

17. The secondary battery of claim 16, wherein the catholyte further comprises a compound represented by Formula 1 or Formula 2: 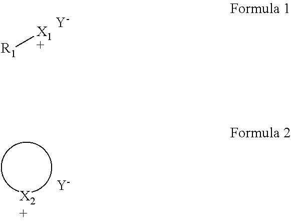
wherein, in Formula 1, X₁ is —N(R₂)(R₃)(R₄) or —P(R₂)(R₃)(R₄), and R₁, R₂, R₃, and R₄ are each independently an unsubstituted or halogen-substituted C1-C30 alkyl group, an unsubstituted or halogen-substituted C1-C30 alkoxy group, an unsubstituted or halogen-substituted C6-C30 aryl group. group, an unsubstituted or halogen-substituted C6-C30 aryloxy group, an unsubstituted or halogen-substituted C3-C30 heteroaryl group, an unsubstituted or halogen-substituted C3-C30 heteroaryloxy group, an unsubstituted or halogen-substituted C4-C30 cycloalkyl group, an unsubstituted or halogen-substituted C3-C30 heterocycloalkyl group, or an unsubstituted or halogen-substituted C2-C100 alkylene oxide group, and
wherein, in Formula 2, 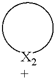
is a heterocycloalkyl ring or heteroaryl ring comprising 1 to 3 heteroatoms and 2 to 30 carbon atoms, the ring is unsubstituted or substituted with a substituent, X₂ is —N(R₅)(R₆), —N(R₅)═, —P(R₅)(R₆), or —P(R₅)═, R₅, and R₆ are each independently hydrogen, an unsubstituted or halogen-substituted C1-C30 alkyl group, an unsubstituted or halogen-substituted C1-C30 alkoxy group, an unsubstituted or halogen-substituted C6-C30 aryl group. group, an unsubstituted or halogen-substituted C6-C30 aryloxy group, an unsubstituted or halogen-substituted C3-C30 heteroaryl group, an unsubstituted or halogen-substituted C3-C30 heteroaryloxy group, an unsubstituted or halogen-substituted C4-C30 cycloalkyl group, an unsubstituted or halogen-substituted C3-C30 heterocycloalkyl group, or an unsubstituted or halogen-substituted C2-C100 alkylene oxide group, and
Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, bis(oxalate)borate, CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

18. The secondary battery of claim 16, wherein the catholyte further comprises a compound represented by Formula 3 or 4: 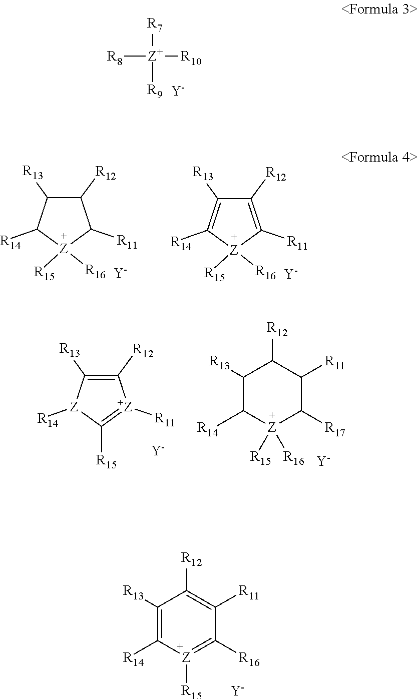
wherein, in Formula 3, Z is N or P, and R₇, R₈, R₉ and R₁₀ are each independently an unsubstituted or halogen-substituted C1-C30 alkyl group, an unsubstituted or halogen-substituted C6-C30 aryl group, an unsubstituted or halogen-substituted C3-C30 heteroaryl group, an unsubstituted or halogen-substituted C4-C30 cycloalkyl group, or an unsubstituted or halogen-substituted C3-C30 heterocycloalkyl group, and
wherein, in Formula 4, Z is N or P, R₁₁, R₁₂, R₁₃, R₁₄, R₁₅, R₁₆, and R₁₇ are each independently hydrogen, an unsubstituted or halogen-substituted C1-C30 alkyl group, an unsubstituted or halogen-substituted C6-C30 aryl group, an unsubstituted or halogen-substituted C3-C30 heteroaryl group, an unsubstituted or halogen-substituted C4-C30 cycloalkyl group, or an unsubstituted or halogen-substituted C3-C30 heterocycloalkyl group, and
Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, bis(oxalate)borate, CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

19. The secondary battery of claim 16, wherein the catholyte further comprises 1-ethyl-1-methylimidazolium bis(fluorosulfonyl)imide, 1-methyl-1-propylpyrrolidinium bis(fluorosulfonyl)imide, 1-methyl-1-butylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, 1,3,5-trimethyl-1H-imidazol-3-ium bis(fluorosulfonyl)imide, or a combination thereof.

20. The secondary battery of claim 16, wherein the fluorinated solvent comprises 3-(2,2,3,3-tetrafluoropropoxy)propanenitrile, 3-(2,2,3,3,3-pentafluoropropoxy)propanenitrile, 3-(2,2,3,3-tetrafluoropropoxy)propanenitrile, 3-(2,2,3,3-tetrafluoropropoxy)propanenitrile, 3-(2,2,3,3-tetrafluoropropoxy)propanenitrile, 3-(2,2,3,3-tetrafluoropropoxy)propanenitrile, 3-(2,2,3,3-tetrafluoropropoxy)propanenitrile, or a combination thereof.
